(19) United States
(12) Patent Application Publication
(10) Pub. No.: US 2026/0362489 A1
(43) Pub. Date: Nov. 12, 2026

(54) COORDINATED COEXISTENCE OF OPERATING MODE SWITCHING OPERATIONS IN WIRELESS LOCAL AREA NETWORKS (WLANs)

(71) Applicant: SAMSUNG ELECTRONICS CO., LTD., SUWON-SI (KR)

(72) Inventors: YONGSEN MA, MILPITAS, CA (US); SRINIVAS KANDALA, MORGAN HILL, CA (US)

(21) Appl. No.: 19/662,794

(22) Filed: Apr. 29, 2026

Related U.S. Application Data
(60) Provisional application No. 63/801,239, filed on May 7, 2025.

(51) Int. Cl. H04W 74/0816; H04W 52/02

(52) U.S. Cl. CPC H04W 74/0816; H04W 52/0206

(57) ABSTRACT

A method for adjusting operating modes is disclosed in which a station receives an indication that an access point activates a dynamic bandwidth expansion (DBE), the activation causing an expansion of an operating bandwidth, and enables one or more dynamic switching features based on activating the DBE, wherein the dynamic switching features comprise at least one of a dynamic power save (DPS) feature, a non-primary channel access (NPCA) feature, or a dynamic sub-band operation (DSO) feature.

### CROSS-REFERENCE TO RELATED APPLICATION

This application claims the priority benefit under 35 U.S.C. § 119(e) of U.S. Provisional Application No. 63/801,239, filed on May 7, 2025, the disclosure of which is incorporated by reference in its entirety as if fully set forth herein.

### TECHNICAL FIELD

The disclosure generally relates to wireless communication systems and operating mode control in WLANs. More particularly, the subject matter disclosed herein relates to methods, signaling procedures, and system configurations for coordinating coexistence of multiple operating mode switching operations, including scheduled and dynamic switching features, in next-generation systems implemented in accordance with the institute of electrical and electronics engineers (IEEE) 802.11 WLAN specification to improve bandwidth utilization, feature interoperability, and operational efficiency.

### SUMMARY

In an embodiment, a method for adjusting operating modes of a station comprises receiving, by a station, an indication that an access point activates a dynamic bandwidth expansion (DBE), the activation causing an expansion of an operating bandwidth; and enabling, by the station, one or more dynamic switching features based on activating the DBE, wherein the one or more dynamic switching features comprise at least one of a dynamic power save (DPS) feature, a non-primary channel access (NPCA) feature, or a dynamic sub-band operation (DSO) feature.

In another embodiment, a method for adjusting operating modes of a station comprises receiving, by a station, an indication of a time corresponding to a scheduled reduction in operating bandwidth; and adjusting, by the station, one or more parameters of one or more dynamic switching features at the time corresponding to the scheduled reduction in the operating bandwidth, wherein the one or more dynamic switching features comprise at least one of a DPS feature, a NPCA feature, or a DSO feature.

In a further embodiment, a system for adjusting operating modes of a station comprises a memory; and a processing device operatively coupled to the memory, the processing device configured to receive an indication that an access point activates a DBE, the activation causing an expansion of operating bandwidth; and enable one or more dynamic switching features based on activating the DBE, wherein the one or more dynamic switching features comprise at least one of a DPS feature, a NPCA feature, or a DSO feature.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of an example electronic device configured to perform operating mode switching operations according to embodiments of the present disclosure.

FIG. 2 illustrates an example wireless communication environment according to embodiments of the present disclosure.

FIG. 3 sets forth a flowchart illustrating an example method for adjusting one or more operating modes according to embodiments of the present disclosure.

FIG. 4A illustrates an example timing diagram showing coordination between DBE and a DPS feature according to embodiments of the present disclosure.

FIG. 4B sets forth a flowchart illustrating an example method for adjusting one or more parameters of a DPS according to embodiments of the present disclosure.

FIG. 5A illustrates an example timing diagram showing coordination between DBE and a NPCA feature according to embodiments of the present disclosure.

FIG. 5B sets forth a flowchart illustrating an example method for adjusting one or more parameters of a NPCA feature according to embodiments of the present disclosure.

FIG. 6A illustrates an example timing diagram showing coordination between DBE and a DSO feature according to embodiments of the present disclosure.

FIG. 6B sets forth a flowchart illustrating an example method for adjusting one or more parameters of a DSO feature according to embodiments of the present disclosure.

FIG. 7 sets forth a flowchart illustrating an example method for initiating an adjustment to one or more parameters of dynamic switching features according to embodiments of the present disclosure.

FIG. 8 sets forth a flowchart illustrating an example method for determining whether an operating bandwidth demand corresponding to one or more dynamic switching features exceeds a bandwidth capacity of a station and initiating an adjustment in response thereto according to embodiments of the present disclosure.

FIG. 9 sets forth a flowchart illustrating an example method for disabling one or more dynamic switching features according to embodiments of the present disclosure.

FIG. 10 illustrates another example wireless communication environment according to embodiments of the present disclosure.

FIG. 11 sets forth a flowchart illustrating deactivation of a dynamic bandwidth expansion at a time corresponding to a scheduled reduction in operating bandwidth according to embodiments of the present disclosure.

FIG. 12 illustrates an example electronic device architecture in which coordinated coexistence of operating mode switching operations may be implemented according to embodiments of the present disclosure.

### DETAILED DESCRIPTION

Technology related to operating mode control in WLAN systems may enable adaptive bandwidth utilization, power management, and channel access coordination in high throughput and ultra-reliable communication environments. These wireless systems may typically rely on operating mode switching mechanisms to adjust operating bandwidth, capability mode, sub-band allocation, and primary channel selection for one or more stations associated with an access point. Conventional implementations may define DBE as a scheduled bandwidth modification over multiple beacon intervals and may define DPS, DSO, and NPCA as per transmit opportunity switching procedures with distinct signaling formats and operational constraints. As wireless deployments incorporate multiple operating mode switching features within the same basic service set (BSS), independent configuration and signaling of each feature may limit flexibility and reduce efficiency in coordinating bandwidth transitions and feature coexistence across different operating states.

To address these limitations, conventional approaches may restrict simultaneous activation of certain operating mode switching features or may require separate signaling exchanges for each feature transition when a scheduled bandwidth change occurs. Other efforts may focus on statically defining permissible combinations of DBE, DPS, DSO, and NPCA to avoid conflicting states within a BSS. These strategies may enable continued operation within existing specification constraints, but these strategies may also increase signaling overhead and reduce flexibility when a station transitions between expanded and reduced operating bandwidths while maintaining multiple dynamic switching features.

To solve this problem, conventional approaches may configure each operating mode switching feature independently when a scheduled bandwidth expansion or reduction occurs, or may delay activation of certain dynamic switching features until completion of separate control procedures. Other efforts may focus on redefining individual signaling elements for DPS, DSO, or NPCA to accommodate specific bandwidth transitions. These strategies may allow operation within existing specification frameworks, but these strategies may also introduce additional control signaling and reduce flexibility when a station seeks to maintain coordinated coexistence of multiple dynamic switching features during changes in operating bandwidth.

One additional issue with the above approaches is that independent configuration and repeated signaling for each operating mode switching feature can prevent efficient coordination of feature parameters across scheduled bandwidth transitions while still requiring additional control exchanges to maintain consistent operating states. The resulting signaling overhead, transition latency, and configuration complexity can reduce effective throughput and limit the ability of a station to seamlessly operate DPS, DSO, and NPCA within an expanded or reduced operating bandwidth. These constraints can restrict scalability of advanced operating mode control mechanisms and reduce overall spectral efficiency in next-generation WLAN systems.

To overcome these issues, systems and methods are described herein for coordinating coexistence of operating mode switching operations in response to scheduled bandwidth expansion or reduction events. The disclosed techniques may permit a station to receive an indication of a time at which an access point will activate or deactivate a DBE and to enable, disable, or adjust one or more dynamic switching features, including DPS, DSO, and NPCA, in direct response to the scheduled change in operating bandwidth. The station or the access point may modify capability mode parameters, sub-band allocations, or primary channel selections so that feature configurations align with the expanded or reduced operating bandwidth. Selection of parameter adjustments and signaling procedures may be guided by design considerations related to compatibility with existing IEEE 802.11 signaling semantics and desired bandwidth utilization efficiency. The combination of these coordination mechanisms can be tailored to maintain consistent operating states across bandwidth transitions, reduce signaling overhead, and improve flexibility in next-generation WLAN deployments. In some embodiments, termination of the DBE or reduction of the operating bandwidth, including reductions indicated by an operating mode indication (OMI), an operating mode notification (OMN), or an adaptive operation mode (AOM), may cause one or more dynamic switching features to be disabled or adjusted to align with the reduced operating bandwidth.

In some embodiments, an access point may be configured to transmit signaling that indicates activation or deactivation of a DBE or a scheduled reduction in operating bandwidth, including signaling associated with an OMI, an OMN, or an AOM. The access point may further coordinate enabling, disabling, or adjusting one or more dynamic switching features at one or more stations based on the indicated operating bandwidth. For example, the access point may transmit control or management frames that cause a station to enable, disable, or adjust a DPS feature, a NPCA feature, or a DSO feature in response to expansion or reduction of the operating bandwidth. In this manner, coordination of operating mode switching operations may be performed by the access point in addition to, or instead of, the station

The above approaches may improve upon conventional operating mode control techniques because coordinated adjustment of dynamic switching features in response to scheduled bandwidth changes can align feature parameters with the current operating bandwidth without requiring separate control procedures for each feature. The resulting coordination structure may support consistent operating semantics across bandwidth expansion and reduction events while reducing signaling overhead and transition latency between operating states. These improvements may provide more efficient use of spectral resources, enhanced throughput, and increased flexibility for next-generation WLAN systems implementing multiple operating mode switching features.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “dynamic switching feature” refers to a protocol-defined operating mode or function that is capable of being enabled, disabled, or reconfigured during operation of a WLAN. A dynamic switching feature may include, for example, a DPS feature, a NPCA feature, a DSO feature, or other dynamic switching features. A dynamic switching feature may operate on a per-transmission opportunity basis or may respond to control signaling exchanged between a station and an access point. It is understood that while the dynamic switching features described herein may include DPS, NPCA, and DSO features, these features are provided as illustrative examples, and the disclosed techniques are not limited to these specific features. The techniques described herein may be applied to any existing or future protocol-defined feature, operating mode, or capability that is affected by changes in operating bandwidth, including features not explicitly described in this disclosure.

As used herein, the term “DPS feature” refers to a protocol-defined operating mode that enables a station to transition between a low capability mode and a high capability mode during operation of a WLAN. The low capability mode may correspond to operation with reduced bandwidth, reduced spatial streams, or reduced modulation parameters, while the high capability mode may correspond to operation with increased bandwidth, increased spatial streams, or enhanced modulation parameters. Transition between the low capability mode and the high capability mode may be initiated based on control signaling exchanged between a station and an access point and may occur on a per-transmission opportunity basis.

As used herein, the term “DSO feature” refers to a protocol-defined operating mode that enables allocation and use of a designated sub-band within an operating bandwidth for transmission and reception. A DSO feature may permit a station to operate on a DSO sub-band that may extend beyond a previously configured operating bandwidth, subject to signaling and capability constraints. Allocation of a DSO sub-band may be dynamically controlled through signaling exchanged between a station and an access point.

As used herein, the term “NPCA feature” refers to a protocol-defined operating mode that enables a station to contend for and access a non-primary channel when a primary channel is busy. The NPCA feature may define a BSS primary channel and a NPCA primary channel, and a station may switch between the BSS primary channel and the NPCA primary channel based on channel occupancy conditions and signaling exchanged with an access point. Operation of the NPCA feature may be constrained by operating bandwidth limits and protocol-defined rules governing channel access.

As used herein, the term “DBE” refers to a scheduled modification of an operating bandwidth of a BSS in which an access point announces, in advance, expansion of the operating bandwidth for a defined interval. Activation of a DBE causes one or more stations to transition from a normal operating bandwidth to an expanded operating bandwidth, and deactivation of a DBE causes transition back to the normal operating bandwidth.

As used herein, the term “operating bandwidth” refers to a set of frequency resources within which a station is configured to transmit and receive signals at a given time. An operating bandwidth may correspond to a normal operating bandwidth associated with a BSS or to an expanded operating bandwidth associated with activation of a DBE.

As used herein, the term “scheduled reduction in operating bandwidth” refers to a signaling event that specifies a future time at which an operating bandwidth will be reduced from an expanded operating bandwidth to a narrower operating bandwidth. A scheduled reduction in operating bandwidth may be indicated by an OMI, an OMN, or an AOM signaling message.

As used herein, the term “bandwidth capacity of the station” refers to a maximum supported bandwidth that the station can process or utilize based on hardware capability, signaling constraints, or protocol-defined limits. The bandwidth capacity of the station may be compared with an operating bandwidth demand associated with one or more enabled dynamic switching features to determine whether parameter adjustment is required.

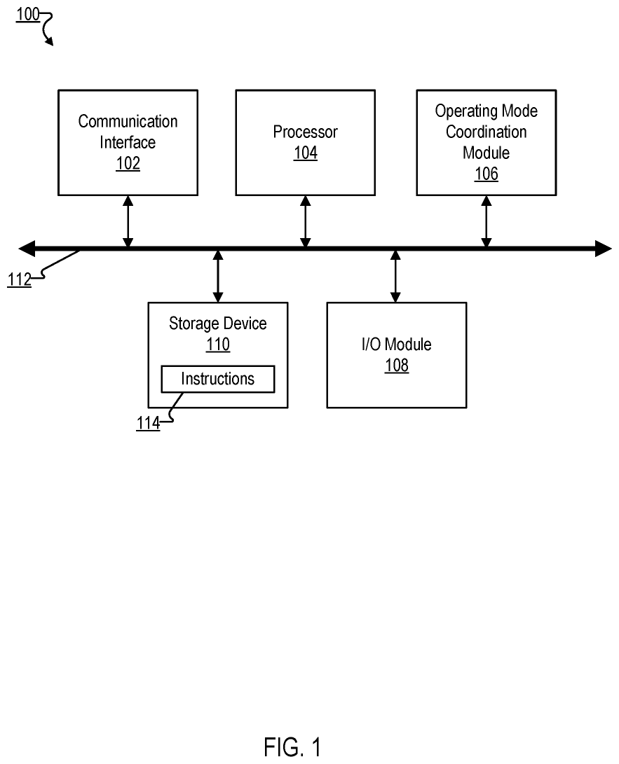

FIG. 1 illustrates an example computing device 100 that may be specifically configured to perform one or more operating mode coordination operations described herein associated with coordinated coexistence of operating mode switching operations in WLANs. As shown in FIG. 1, the computing device 100 may include a communication interface 102, a processor 104, an operating mode coordination module 106, an input and output (I/O) module 108, and a storage device 110 configured to store instructions 114. The communication interface 102, the processor 104, the operating mode coordination module 106, the I/O module 108, and the storage device 110 may be communicatively connected to one another via a communication infrastructure 112. The instructions 114, when executed by the processor 104, may cause the computing device 100 to perform operations associated with receiving an indication of a time at which an access point will activate or deactivate a DBE, receiving an indication associated with activation or deactivation of an OMI, an OMN, or an AOM, enabling one or more dynamic switching features in response to activation or deactivation of the DBE, enabling, disabling, or adjusting one or more dynamic switching features in response to activation or deactivation of the OMI, OMN, or AOM, adjusting parameters of DPS, NPCA, or DSO features to operate within an expanded or reduced operating bandwidth, and disabling or reconfiguring such features in response to scheduled bandwidth changes. Although the computing device 100 is illustrated in FIG. 1, the illustrated components are not intended to be limiting, and additional or alternative components may be used in other embodiments.

The communication interface 102 may be configured to communicate with one or more external systems that provide management frames, control frames, bandwidth change indications, or other signaling information to, or receive transmission frames from, the computing device 100. For example, the communication interface 102 may enable wireless communication with one or more access points, stations, or other network nodes operating in accordance with the IEEE 802.11 WLAN specification, including receipt of signaling that indicates activation or deactivation of a DBE. As another example, the communication interface 102 may enable transmission of control frames, data frames, or operating mode switching information associated with DPS, NPCA, or DSO features. The communication interface 102 may include, without limitation, a radio frequency transceiver, baseband processing circuitry, antenna modules, wired network interfaces, or other communication modules configured for data exchange across local or distributed networking environments. In some embodiments, the communication interface 102 may include encryption, authentication, or access-control mechanisms to support secure transmission of management frames, control signaling, and operating mode coordination information.

The processor 104 generally represents one or more processing units capable of executing operations of the computing device 100 associated with operating mode coordination and dynamic feature control. The processor 104 may execute the instructions 114 stored in the storage device 110 to perform operations including receiving an indication of a time at which an access point will activate or deactivate a DBE, enabling one or more dynamic switching features in response to activation of the DBE, adjusting parameters of DPS, NPCA, or DSO features to operate within an expanded or reduced operating bandwidth, and disabling or reconfiguring such features in response to scheduled bandwidth changes. The processor 104 may include one or more general-purpose processing units, digital signal processors, baseband processors, or other processing resources configured to perform signal processing, medium access control operations, and operating mode control logic. In some embodiments, the processor 104 may coordinate execution across multiple processing cores or hardware accelerators to support real-time processing of bandwidth transition events and dynamic feature adjustments in high-throughput WLAN environments.

The operating mode coordination module 106 may be configured to perform control operations that support coordinated coexistence of operating mode switching features during scheduled bandwidth transitions. The operating mode coordination module 106 may include one or more sub-modules configured to monitor activation and deactivation times of a DBE, enable or disable DPS, NPCA, or DSO features in response to such activation or deactivation, and adjust associated operating parameters to align with an expanded or reduced operating bandwidth. In some embodiments, the operating mode coordination module 106 may implement control logic for modifying low capability bandwidth or high capability bandwidth parameters of a DPS feature, switching between a BSS primary channel and a NPCA primary channel, or switching between a primary sub-band and a dynamic sub-band. In other embodiments, the operating mode coordination module 106 may include logic for determining whether an operating bandwidth demand associated with one or more dynamic switching features exceeds a bandwidth capacity of the computing device 100 and initiating parameter adjustments accordingly. The operating mode coordination module 106 may operate in coordination with the processor 104 to execute the operating mode coordination workflows of the methods described herein. In some embodiments, the operating mode coordination module 106 may disable or adjust one or more dynamic switching features in response to termination of a DBE or in response to operating bandwidth reduction indicated by OMI, OMN, or AOM signaling.

The I/O module 108 may include one or more input and output devices configured to receive configuration input and present operational data generated by the computing device 100. The I/O module 108 may include any suitable combination of hardware, firmware, and software that supports configuration, monitoring, and visualization of operating mode coordination operations. For input, the I/O module 108 may include interfaces for configuring DBE parameters, OMI, OMN, or AOM parameters, enabling or disabling DPS, NPCA, or DSO features, and defining thresholds or policies for adjusting feature parameters during scheduled bandwidth transitions. For output, the I/O module 108 may include displays, dashboards, logs, or graphical user interfaces (GUIs) configured to present operating bandwidth status information, feature enablement states, primary channel or sub-band selections, and performance indicators associated with coordinated coexistence of operating mode switching operations.

The storage device 110 may include one or more types of non-volatile storage media and may be configured to store the instructions 114 along with data used or generated by the computing device 100. The storage device 110 may maintain operating bandwidth configuration parameters, scheduled activation and deactivation times associated with DBE, feature enablement states for DPS, NPCA, and DSO, and parameter values such as low capability bandwidth, high capability bandwidth, primary channel selections, and sub-band allocations. In some embodiments, the storage device 110 may include structured data repositories or databases configured to organize historical bandwidth transition events, feature adjustment records, capability information associated with the computing device 100, and policy parameters governing coordinated coexistence of operating mode switching operations to support traceability, analysis, auditing, and continued optimization of operating mode coordination. The storage device 110 may further integrate with distributed or network-based storage resources to enable scalable data management across local, distributed, or networked computing environments.

The communication infrastructure 112 represents an internal interconnect architecture that links the communication interface 102, the processor 104, the operating mode coordination module 106, the I/O module 108, and the storage device 110 within the computing device 100. The communication infrastructure 112 may support exchange of operating bandwidth configuration parameters, scheduled bandwidth transition indications, dynamic feature enablement states, parameter adjustment values, policy settings, and control signals between components of the computing device 100. In some embodiments, the communication infrastructure 112 may be implemented using one or more buses, high-speed interconnect fabrics, or network-on-chip architectures configured to provide sufficient throughput and latency characteristics to support coordinated execution of bandwidth transition handling, feature parameter modification, control frame processing, and operating mode coordination operations described herein.

The instructions 114 stored in the storage device 110 may define operations that, when executed by the processor 104, enable the computing device 100 to perform one or more processes associated with coordinated coexistence of operating mode switching operations. The instructions 114 may include routines for receiving an indication of a time at which an access point will activate or deactivate a DBE, enabling one or more dynamic switching features in response to activation of the DBE, adjusting parameters of DPS, NPCA, or DSO features to align with an expanded or reduced operating bandwidth, determining whether an operating bandwidth demand exceeds a bandwidth capacity of the computing device 100, and disabling or reconfiguring dynamic switching features in response to scheduled bandwidth changes. When executed, the instructions 114 may coordinate operation of the communication interface 102, the processor 104, the operating mode coordination module 106, the I/O module 108, and the storage device 110 to enable the computing device 100 to function as an integrated platform for managing bandwidth transitions and maintaining consistent operating states across multiple dynamic switching features.

By combining these components, the computing device 100 is configured to execute the processes described herein for coordinating coexistence of operating mode switching operations during scheduled bandwidth expansion and reduction events. In particular, the computing device 100 supports operations including receiving an indication of activation or deactivation of a DBE, enabling one or more dynamic switching features in response to activation of the DBE, adjusting low capability bandwidth or high capability bandwidth parameters of a DPS feature, switching between a BSS primary channel and an NPCA primary channel, switching between a primary sub-band and a dynamic sub-band, determining whether an operating bandwidth demand exceeds a bandwidth capacity of the computing device 100, and disabling or reconfiguring dynamic switching features in response to scheduled bandwidth changes. The integrated architecture of the computing device 100 may enable coordinated control of bandwidth transitions and dynamic feature adjustments under signaling and timing constraints defined by the IEEE 802.11 WLAN specification.

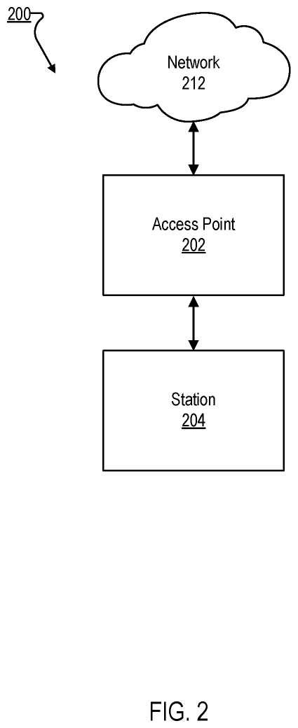

FIG. 1 therefore illustrates an example computing device configured to perform one or more operating mode coordination operations described herein. The described configuration may enable the computing device to receive scheduled indications of DBE activation or deactivation, enable or disable DPS, NPCA, and DSO features, adjust associated operating parameters to align with an expanded or reduced operating bandwidth, and maintain consistent operating states in accordance with IEEE 802.11 signaling semantics. FIG. 2 sets forth an example wireless communication environment in accordance with embodiments of the present disclosure.

In one or more embodiments, FIG. 2 illustrates an example wireless communication environment 200 in which the computing device 100 of FIG. 1 may be deployed to perform operating mode coordination operations in accordance with embodiments of the present disclosure. The wireless communication environment 200 may include at least one access point 202, one or more stations 204, and a network 212 communicatively coupling the access point 202 and the one or more stations 204 within a WLAN implemented in accordance with the IEEE 802.11 WLAN specification. In some embodiments, the computing device 100 may be implemented within the station 204 to receive scheduled indications of DBE from the access point 202 and to adjust DPS, NPCA, or DSO features accordingly. In other embodiments, the computing device 100 may be implemented within the access point 202 or within a network-based control entity coupled to the network 212 and configured to coordinate bandwidth transition signaling among multiple access points 202 and stations 204. The computing device 100, when deployed within or communicatively coupled to the network 212, may manage transmission and receipt of management frames and control frames associated with dynamic bandwidth expansion and operating mode indication procedures under signaling and timing constraints governed by the IEEE 802.11 WLAN specification.

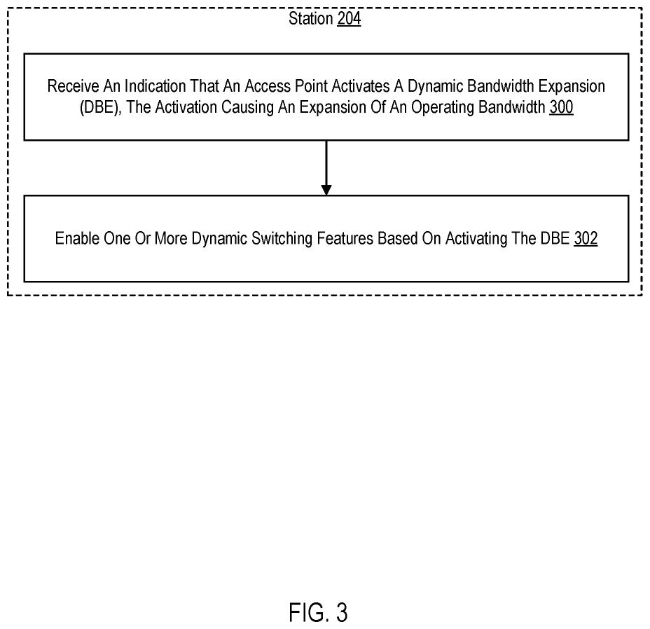

FIG. 2 therefore illustrates an example wireless communication environment in which coordinated coexistence of operating mode switching operations may be performed by a station in response to bandwidth transition signaling from an access point. Within the wireless communication environment, the station may receive scheduled indications of DBE activation or deactivation and may adjust one or more dynamic switching features to maintain alignment with a current operating bandwidth. FIG. 3 sets forth a flowchart illustrating an example method executed by the station for enabling one or more dynamic switching features in response to activation of a DBE in accordance with embodiments of the present disclosure.

For further explanation, FIG. 3 sets forth a flowchart illustrating an example method of adjusting one or more operating modes in response to activation of a DBE in accordance with embodiments of the present disclosure. The example method of FIG. 3 can be carried out in a system similar to that of FIGS. 1 and 2. The method of FIG. 3 can be performed by a station (e.g., the station 204) configured to receive an indication of activation of a DBE from an access point (e.g., the access point 202) and to enable one or more dynamic switching features in response thereto.

The method of FIG. 3 includes receiving 300, by the station, an indication of a time at which the access point will activate a DBE, the activation causing an operating bandwidth of the station to be expanded. Receiving 300 the indication may be carried out by receiving a management frame, control frame, or other signaling message transmitted by the access point 202 that specifies a scheduled activation time associated with the DBE. In one or more examples, receiving 300 the indication may include extracting timing information from one or more signaling fields that define a start time for the expanded operating bandwidth and, in some embodiments, a corresponding stop time. Receiving 300 the indication may further include determining, based on the extracted timing information, when the operating bandwidth of the station 204 will transition from a current bandwidth to an expanded operating bandwidth in accordance with IEEE 802.11 WLAN signaling semantics.

In some embodiments, receiving 300 the indication may include identifying that the indication corresponds to activation of the DBE rather than deactivation of the DBE. For example, receiving 300 the indication may include evaluating one or more signaling fields that distinguish between expansion of a BSS operating bandwidth and reduction of the BSS operating bandwidth. In other embodiments, receiving 300 the indication may include determining whether the station 204 supports operation within the expanded operating bandwidth based on stored capability information. Receiving 300 the indication may further include preparing internal operating mode state information so that subsequent dynamic switching feature adjustments can be applied at the scheduled activation time in accordance with medium access control rules specified by the IEEE 802.11 WLAN specification.

The method of FIG. 3 also includes enabling 302, by the station, one or more dynamic switching features in response to activating the DBE, wherein the dynamic switching features comprise at least one of a DPS feature, a NPCA feature, or a DSO feature. Enabling 302 the one or more dynamic switching features may be carried out by activating at least one of the DPS feature, the NPCA feature, or the DSO feature at or after the scheduled activation time associated with the DBE. In one or more examples, enabling 302 the one or more dynamic switching features may include transitioning a feature from a disabled state to an enabled state based on stored configuration parameters and capability information associated with the station 204. In some embodiments, enabling 302 the one or more dynamic switching features may further include adjusting one or more parameters of the enabled dynamic switching features to align operation with the expanded operating bandwidth. Enabling 302 the one or more dynamic switching features may further include configuring the enabled feature to operate within the expanded operating bandwidth in accordance with signaling and operational constraints defined by the IEEE 802.11 WLAN specification.

In some embodiments, enabling 302 the one or more dynamic switching features may include enabling the DPS feature so that the station 204 can transition between a low capability mode and a high capability mode within the expanded operating bandwidth. In other embodiments, enabling 302 the one or more dynamic switching features may include enabling the NPCA feature so that the station 204 can access a secondary channel when a primary channel is busy within the expanded operating bandwidth. In further embodiments, enabling 302 the one or more dynamic switching features may include enabling the DSO feature so that the station 204 can operate on a dynamic sub-band allocated within the expanded operating bandwidth. Enabling 302 the one or more dynamic switching features may be conditioned on compliance with capability limits and operational rules specified by the IEEE 802.11 WLAN specification.

The method steps of FIG. 3 collectively describe a process for enabling coordinated coexistence of operating mode switching operations in response to activation of a DBE. Receiving 300 the indication of the scheduled activation time and enabling 302 the one or more dynamic switching features cooperate to align feature configuration with an expanded operating bandwidth. Through these operations, the station may transition from a first operating state associated with a current operating bandwidth to a second operating state associated with the expanded operating bandwidth while maintaining compliance with signaling and capability constraints defined by the IEEE 802.11 WLAN specification. The coordinated execution of receiving 300 the indication and enabling 302 the one or more dynamic switching features may reduce redundant control exchanges, minimize transition latency, and improve bandwidth utilization during scheduled bandwidth expansion events.

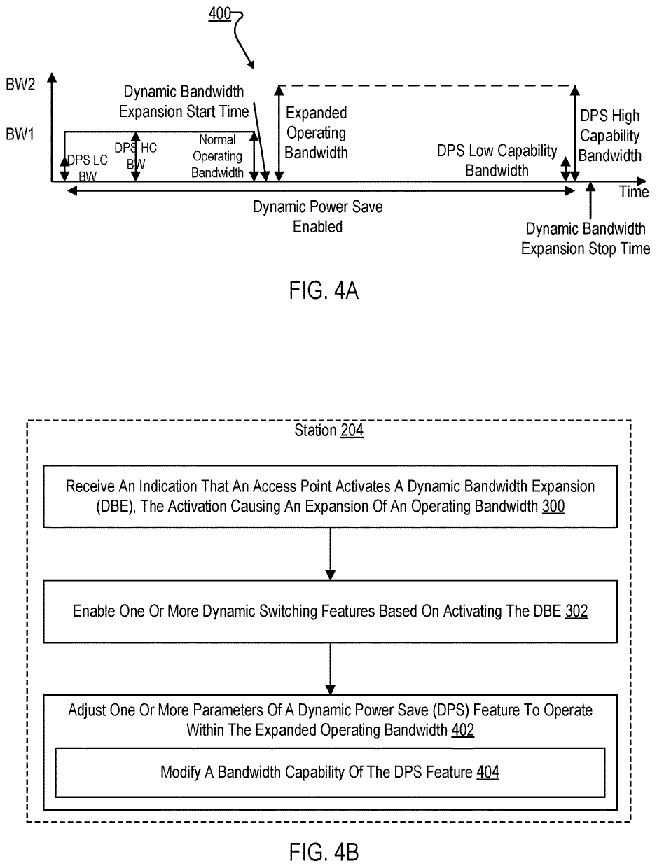

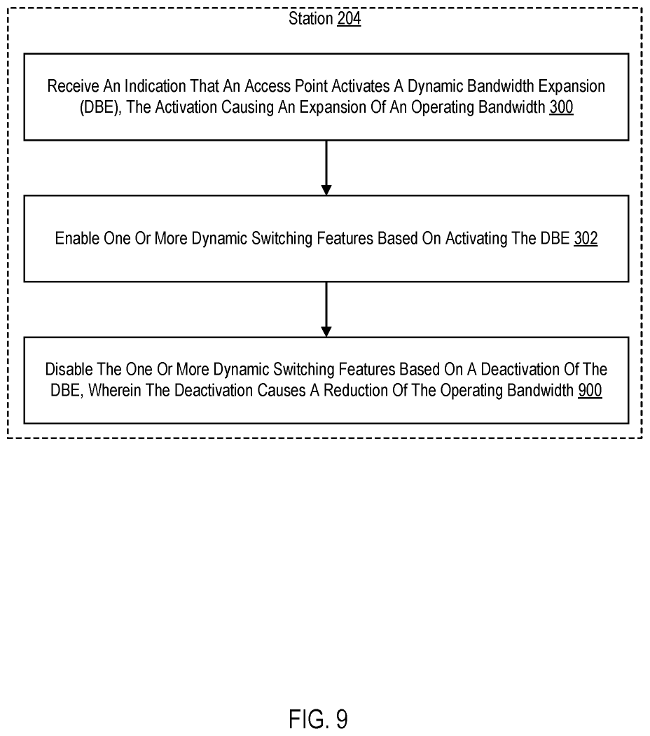

FIG. 3 therefore illustrates an example method executed by the station for adjusting one or more operating modes in response to activation of a DBE. The sequence of operations shown in FIG. 3 demonstrates how the station may transition from receiving 300 a scheduled indication of DBE activation to enabling 302 one or more dynamic switching features configured to operate within the expanded operating bandwidth. FIG. 4A and FIG. 4B set forth example timing diagrams and flowcharts that expand upon the operations described with reference to FIG. 3 by detailing additional operations associated with adjusting parameters of a DPS feature in coordination with activation of a DBE, as further described herein. Termination of the DBE and corresponding adjustment or disabling of the one or more dynamic switching features are described with reference to FIGS. 9-11.

For further explanation, FIG. 4A illustrates an example timing diagram 400 depicting coordination between activation of a DBE and operation of a DPS feature in accordance with embodiments of the present disclosure. The example timing diagram 400 of FIG. 4A can be carried out in a system similar to that of FIGS. 1 and 2. The timing relationships illustrated in FIG. 4A may correspond to operations performed by a station (e.g., the station 204) that enables and adjusts a DPS feature in response to activation of a DBE initiated by an access point (e.g., the access point 202).

FIG. 4A illustrates a first time interval during which the station 204 operates within a normal operating bandwidth prior to a scheduled DBE start time. At the DBE start time, the operating bandwidth transitions from the normal operating bandwidth to an expanded operating bandwidth that may include additional frequency segments identified as BW1 and BW2. During the expanded operating bandwidth interval, the DPS feature may be enabled so that the station 204 can operate in either a DPS low capability bandwidth or a DPS high capability bandwidth aligned with the expanded operating bandwidth. The timing diagram further illustrates a DBE stop time at which the operating bandwidth returns from the expanded operating bandwidth to the normal operating bandwidth, thereby establishing defined intervals during which DPS configuration may be adjusted in coordination with activation and termination of the DBE.

In some embodiments, the DPS low capability bandwidth and the DPS high capability bandwidth illustrated in FIG. 4A may be configured such that the DPS high capability bandwidth corresponds to the expanded operating bandwidth during the DBE interval, while the DPS low capability bandwidth corresponds to the BSS operating bandwidth or to a bandwidth narrower than the BSS operating bandwidth. For example, the station 204 may configure the DPS high capability bandwidth to span BW1 and BW2 within the expanded operating bandwidth while maintaining the DPS low capability bandwidth at a narrower portion of the BSS operating bandwidth. In other embodiments, the station 204 may adjust the DPS low capability bandwidth and the DPS high capability bandwidth at or after the DBE start time so that the DPS high capability bandwidth aligns with frequency resources available during the expanded operating bandwidth interval. Upon occurrence of the DBE stop time, the station 204 may revert the DPS high capability bandwidth to a value compatible with the BSS operating bandwidth.

In some embodiments, prior to the DBE start time, the DPS feature may be disabled or may be configured such that a low capability mode corresponds to the normal operating bandwidth of the BSS, which may effectively result in the DPS feature being inactive. For example, the station 204 may operate with the DPS feature disabled or configured with a low capability bandwidth equal to the normal operating bandwidth, thereby limiting operation to the BSS bandwidth prior to activation of the DBE. Upon activation of the DBE, the station 204 may enable the DPS feature or adjust the DPS feature so that a high capability bandwidth corresponds to the expanded operating bandwidth. In one or more examples, the station 204 may transition from operation in which the DPS feature is disabled or implicitly inactive to operation in which the DPS feature is enabled with a high capability mode spanning BW1 and BW2 during the expanded operating bandwidth interval.

The timing relationships illustrated in FIG. 4A demonstrate how activation and termination of the DBE define boundaries for coordinated adjustment of DPS parameters. By aligning the DPS low capability bandwidth and the DPS high capability bandwidth with the expanded operating bandwidth during the DBE interval, the station 204 may maintain consistent operating states and avoid operation outside the available frequency resources. When the operating bandwidth transitions back to the normal operating bandwidth at the DBE stop time, the station 204 may adjust or restrict DPS operation to comply with the reduced bandwidth. FIG. 4B sets forth a flowchart illustrating an example method that details operations associated with adjusting one or more parameters of the DPS feature in coordination with activation of the DBE.

For further explanation, FIG. 4B sets forth a flow chart illustrating an example method for adjusting one or more parameters of a DPS feature in coordination with activation of a DBE in accordance with embodiments of the present disclosure. The operations shown in FIG. 4B may be performed by the station 204 following receipt of a scheduled indication of DBE activation and may further refine the enabling 302 operation described with reference to FIG. 3. The flowchart of FIG. 4B illustrates how the station 204 may modify DPS configuration parameters so that the DPS feature operates within the expanded operating bandwidth established by activation of the DBE.

The method of FIG. 4B discloses performance of receiving 300 the indication of activation of the DBE and enabling 302 the one or more dynamic switching features, including the DPS feature, as described with reference to FIG. 3, which may precede adjusting 402 one or more parameters of the DPS feature, as further described herein. In the method of FIG. 4B, receiving 300 the indication and enabling 302 the DPS feature may be performed as described with reference to FIG. 3 such that the DPS feature is active prior to parameter modification. Following enabling 302 the DPS feature, the method of FIG. 4B may include adjusting 402 one or more parameters of the DPS feature to operate within the expanded operating bandwidth. Performance of enabling 302 the DPS feature prior to adjusting 402 the one or more parameters may ensure that subsequent parameter modification occurs in coordination with activation of the DBE and within bandwidth constraints established by the expanded operating bandwidth.

More specifically, adjusting 402 the one or more parameters of the DPS feature may be carried out by modifying configuration values associated with a DPS low capability bandwidth or a DPS high capability bandwidth so that the DPS feature operates within the expanded operating bandwidth established by activation of the DBE. Adjusting 402 the one or more parameters may include updating internal state information that defines a maximum bandwidth, number of spatial streams, or modulation and coding scheme parameters permitted during operation of the DPS feature. Adjusting 402 the one or more parameters may therefore align operation of the DPS feature with frequency resources available during the expanded operating bandwidth interval. Performance of adjusting 402 the one or more parameters may establish a configuration in which subsequent transmissions and receptions performed under the DPS feature remain within bandwidth limits defined by activation of the DBE.

In some embodiments, adjusting 402 the one or more parameters of the DPS feature may include selecting a low capability bandwidth or a high capability bandwidth consistent with operation within the expanded operating bandwidth established by activation of the DBE. For example, adjusting 402 the one or more parameters may include configuring the high capability bandwidth so that transmissions performed under the DPS feature span BW1 and BW2 during the expanded operating bandwidth interval. In other embodiments, adjusting 402 the one or more parameters may include synchronizing application of modified DPS bandwidth parameters with the scheduled DBE activation time to ensure that the station 204 transitions to the updated configuration at a defined operating boundary. Adjusting 402 the one or more parameters in accordance with selected bandwidth values and timing constraints may enable the station 204 to operate the DPS feature efficiently within the expanded operating bandwidth while maintaining compliance with IEEE 802.11 signaling semantics.

In the method of FIG. 4B, adjusting 402 the one or more parameters of the DPS feature includes modifying 404 at least one of a low capability bandwidth of the DPS feature or a high capability bandwidth of the DPS feature. Modifying 404 the low capability bandwidth may be carried out by reconfiguring a default operating mode of the DPS feature so that the low capability bandwidth corresponds to a portion of the expanded operating bandwidth. Modifying 404 the high capability bandwidth may be carried out by updating a higher capability operating mode so that the high capability bandwidth spans frequency resources available within the expanded operating bandwidth. In one or more examples, modifying 404 the low capability bandwidth and the high capability bandwidth may include updating stored bandwidth parameters and applying the updated parameters at the scheduled DBE activation time to ensure that DPS operation remains aligned with the expanded operating bandwidth.

In some embodiments, modifying 404 the low capability bandwidth or the high capability bandwidth may include selecting bandwidth values based on capability information associated with the station 204. For example, modifying 404 the high capability bandwidth may include selecting a maximum supported bandwidth that does not exceed the expanded operating bandwidth defined by the DBE. In other embodiments, modifying 404 the low capability bandwidth may include configuring a reduced bandwidth mode that remains within the expanded operating bandwidth while conserving power or limiting processing load. Modifying 404 the low capability bandwidth or the high capability bandwidth in accordance with capability limits and operational policies may enable the station 204 to maintain compliant and efficient operation of the DPS feature during the DBE interval.

The method steps of FIG. 4B collectively describe a process for adjusting parameters of a DPS feature in coordination with activation of a DBE. Receiving 300 the indication of the scheduled activation time, enabling 302 the DPS feature, and adjusting 402 the one or more parameters, including modifying 404 at least one of the low capability bandwidth or the high capability bandwidth, cooperate to align DPS operation with the expanded operating bandwidth. Through these operations, the station may transition from a DPS configuration associated with a normal operating bandwidth to a DPS configuration associated with the expanded operating bandwidth while maintaining compliance with signaling and capability constraints defined by the IEEE 802.11 WLAN specification. The coordinated execution of enabling 302 the DPS feature and adjusting 402 the one or more parameters may reduce configuration inconsistencies, minimize transition latency, and improve bandwidth utilization during scheduled DBE activation events.

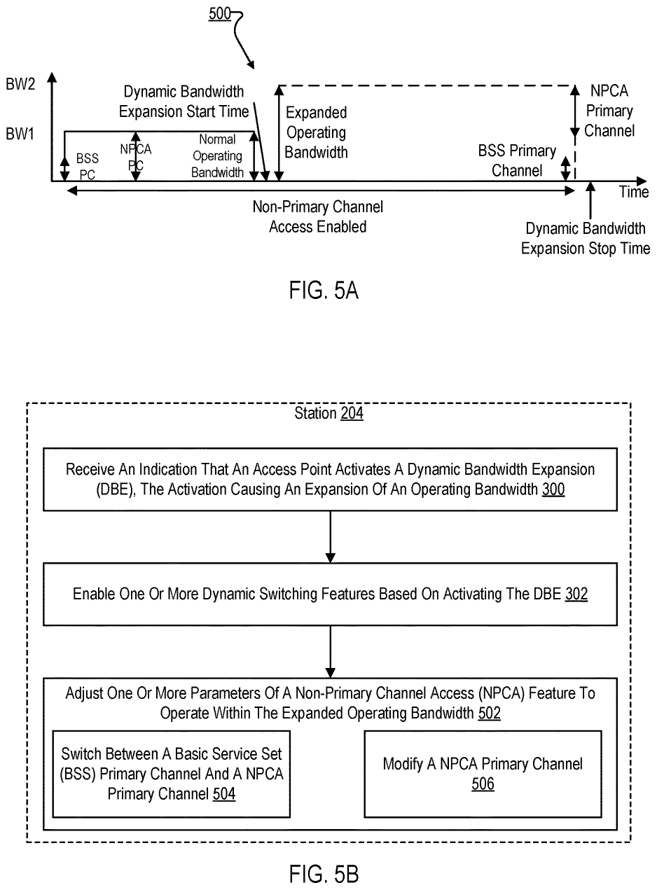

FIG. 4B therefore illustrates an example method executed by the station for adjusting one or more parameters of a DPS feature in response to activation of a DBE. The sequence of operations shown in FIG. 4B demonstrates how the station may transition from enabling 302 the DPS feature to adjusting 402 the one or more parameters, including modifying 404 the low capability bandwidth or the high capability bandwidth, so that DPS operation remains within the expanded operating bandwidth. FIG. 5A and FIG. 5B set forth example timing diagrams and flowcharts that expand upon the operations described with reference to FIG. 3 by detailing additional operations associated with adjusting parameters of a NPCA feature in coordination with activation of a DBE, as further described herein.

For further explanation, FIG. 5A illustrates an example timing diagram 500 depicting coordination between activation of a DBE and operation of a NPCA feature in accordance with embodiments of the present disclosure. The example timing diagram 500 of FIG. 5A can be carried out in a system similar to that of FIGS. 1 and 2. The timing relationships illustrated in FIG. 5A may correspond to operations performed by a station (e.g., the station 204) that enables and adjusts a NPCA feature in response to activation of a DBE initiated by an access point (e.g., the access point 202).

FIG. 5A illustrates a first time interval during which the station 204 operates within a normal operating bandwidth prior to a scheduled DBE start time. At the DBE start time, the operating bandwidth transitions from the normal operating bandwidth to an expanded operating bandwidth that may include additional frequency segments identified as BW1 and BW2. During the expanded operating bandwidth interval, the NPCA feature may be enabled or adjusted so that the station 204 can access a BSS primary channel or a NPCA primary channel aligned with the expanded operating bandwidth. The timing diagram further illustrates a DBE stop time at which the operating bandwidth returns from the expanded operating bandwidth to the normal operating bandwidth, thereby establishing defined intervals during which NPCA configuration may be adjusted in coordination with activation and termination of the DBE.

In some embodiments, the BSS primary channel and the NPCA primary channel illustrated in FIG. 5A may be configured so that the NPCA primary channel corresponds to frequency resources within the expanded operating bandwidth during the DBE interval. For example, the station 204 may configure the NPCA primary channel to reside within BW1 or BW2 of the expanded operating bandwidth while maintaining the BSS primary channel within a predefined portion of the operating bandwidth. In other embodiments, the station 204 may adjust the NPCA primary channel at or after the DBE start time so that channel access operations align with frequency resources available during the expanded operating bandwidth interval. Upon occurrence of the DBE stop time, the station 204 may revert the NPCA primary channel to values compatible with the normal operating bandwidth.

The timing relationships illustrated in FIG. 5A demonstrate how activation and termination of the DBE define boundaries for coordinated adjustment of NPCA parameters. By aligning the NPCA primary channel with the expanded operating bandwidth during the DBE interval, the station 204 may maintain consistent channel access behavior and avoid operation outside available frequency resources. When the operating bandwidth transitions back to the normal operating bandwidth at the DBE stop time, the station 204 may adjust or restrict NPCA operation to comply with the reduced bandwidth. FIG. 5B sets forth a flowchart illustrating an example method that details operations associated with adjusting one or more parameters of the NPCA feature in coordination with activation of the DBE.

For further explanation, FIG. 5B sets forth a flowchart illustrating an example method for adjusting one or more parameters of a NPCA feature in coordination with activation of a DBE in accordance with embodiments of the present disclosure. The operations shown in FIG. 5B may be performed by the station 204 following receipt of a scheduled indication of DBE activation and may further refine the enabling 302 operation described with reference to FIG. 3. The flowchart of FIG. 5B illustrates how the station 204 may modify NPCA configuration parameters so that the NPCA feature operates within the expanded operating bandwidth established by activation of the DBE.

The method of FIG. 5B discloses performance of receiving 300 the indication of activation of the DBE and enabling 302 the one or more dynamic switching features, including the NPCA feature, as described with reference to FIG. 3, which may precede adjusting 502 one or more parameters of the NPCA feature, as further described herein. In the method of FIG. 5B, receiving 300 the indication and enabling 302 the NPCA feature may be performed as described with reference to FIG. 3 such that the NPCA feature is active prior to parameter modification. Following enabling 302 the NPCA feature, the method of FIG. 5B may include adjusting 502 one or more parameters of the NPCA feature to operate within the expanded operating bandwidth. Performance of enabling 302 the NPCA feature prior to adjusting 502 the one or more parameters may ensure that subsequent parameter modification occurs in coordination with activation of the DBE and within bandwidth constraints established by the expanded operating bandwidth.

More specifically, adjusting 502 the one or more parameters of the NPCA feature may be carried out by modifying configuration values associated with a NPCA primary channel so that the NPCA feature operates within the expanded operating bandwidth established by activation of the DBE. Adjusting 502 the one or more parameters may include updating internal state information that defines which primary channel the station 204 uses for contention when a BSS primary channel is busy. Adjusting 502 the one or more parameters may therefore align operation of the NPCA feature with frequency resources available during the expanded operating bandwidth interval. Performance of adjusting 502 the one or more parameters may establish a configuration in which subsequent channel access operations performed under the NPCA feature remain within bandwidth limits defined by activation of the DBE.

In some embodiments, adjusting 502 the one or more parameters of the NPCA feature may include selecting a NPCA primary channel consistent with operation within the expanded operating bandwidth established by activation of the DBE. For example, adjusting 502 the one or more parameters may include configuring the NPCA primary channel so that channel access operations occur within BW1 or BW2 during the expanded operating bandwidth interval. In other embodiments, adjusting 502 the one or more parameters may include synchronizing application of modified NPCA channel selections with the scheduled DBE activation time to ensure that the station 204 transitions to the updated configuration at a defined operating boundary. Adjusting 502 the one or more parameters in accordance with selected channel values and timing constraints may enable the station 204 to operate the NPCA feature efficiently within the expanded operating bandwidth while maintaining compliance with IEEE 802.11 signaling semantics.

In the method of FIG. 5B, adjusting 502 the one or more parameters of the NPCA feature includes switching 504 between channel access on a BSS primary channel and channel access on a NPCA primary channel or modifying 506 the NPCA primary channel as is further described herein.

More specifically, adjusting 502 the one or more parameters of the NPCA feature includes switching 504 between channel access on a BSS primary channel and channel access on a NPCA primary channel. Switching 504 between channel access on the BSS primary channel and channel access on the NPCA primary channel may be carried out by updating channel selection so that contention operations are performed on the NPCA primary channel when the BSS primary channel is busy. In one or more examples, switching 504 may include detecting a condition in which the BSS primary channel is occupied and transitioning channel access procedures to the NPCA primary channel within the expanded operating bandwidth. Switching 504 between channel access on the BSS primary channel and channel access on the NPCA primary channel may enable the station 204 to maintain channel access opportunities while remaining within frequency resources defined by activation of the DBE.

In some embodiments, switching 504 between channel access on the BSS primary channel and channel access on the NPCA primary channel may include selecting the NPCA primary channel based on frequency availability within the expanded operating bandwidth established by activation of the DBE. For example, switching 504 between channel access on the BSS primary channel and channel access on the NPCA primary channel may include identifying that the BSS primary channel resides within a first portion of the expanded operating bandwidth and selecting the NPCA primary channel within a second portion of the expanded operating bandwidth that is not currently occupied. In other embodiments, switching 504 between channel access on the BSS primary channel and channel access on the NPCA primary channel may include synchronizing the transition between the BSS primary channel and the NPCA primary channel with medium access control timing constraints defined by the IEEE 802.11 WLAN specification. Switching 504 between channel access on the BSS primary channel and channel access on the NPCA primary channel in accordance with selected channel values and timing constraints may enable the station 204 to efficiently utilize additional frequency resources made available during the DBE interval.

In addition, adjusting 502 the one or more parameters of the NPCA feature also includes modifying 506 the NPCA primary channel. Modifying 506 the NPCA primary channel may be carried out by selecting a new NPCA primary channel within the expanded operating bandwidth to improve channel access efficiency or by keeping a previously selected NPCA primary channel unchanged based on channel conditions. In one or more examples, modifying 506 the NPCA primary channel may include updating stored channel configuration parameters and applying the updated parameters at the scheduled DBE activation time so that NPCA operation remains aligned with frequency resources available during the expanded operating bandwidth interval.

In some embodiments, modifying 506 the NPCA primary channel may include selecting a channel value based on channel occupancy information, interference measurements, or policy constraints associated with the station 204. For example, modifying 506 the NPCA primary channel may include selecting a secondary channel within the expanded operating bandwidth that exhibits lower interference or reduced contention relative to other available channels or keeping a previously selected NPCA primary channel unchanged based on such conditions. In one or more examples, modifying 506 the NPCA primary channel in accordance with selected channel values and operational constraints may enable the station 204 to maintain compliant and efficient NPCA operation during the DBE interval.

The method steps of FIG. 5B collectively describe a process for adjusting parameters of a NPCA feature in coordination with activation of a DBE. Receiving 300 the indication of the scheduled activation time, enabling 302 the NPCA feature, and adjusting 502 the one or more parameters, including switching 504 between channel access on a BSS primary channel and channel access on a NPCA primary channel or modifying 506 the NPCA primary channel, cooperate to align NPCA operation with the expanded operating bandwidth. Through these operations, the station may transition from a NPCA configuration associated with a normal operating bandwidth to a NPCA configuration associated with the expanded operating bandwidth while maintaining compliance with signaling and capability constraints defined by the IEEE 802.11 WLAN specification. The coordinated execution of enabling 302 the NPCA feature and adjusting 502 the one or more parameters may reduce configuration inconsistencies, minimize transition latency, and improve channel access efficiency during scheduled DBE activation events.

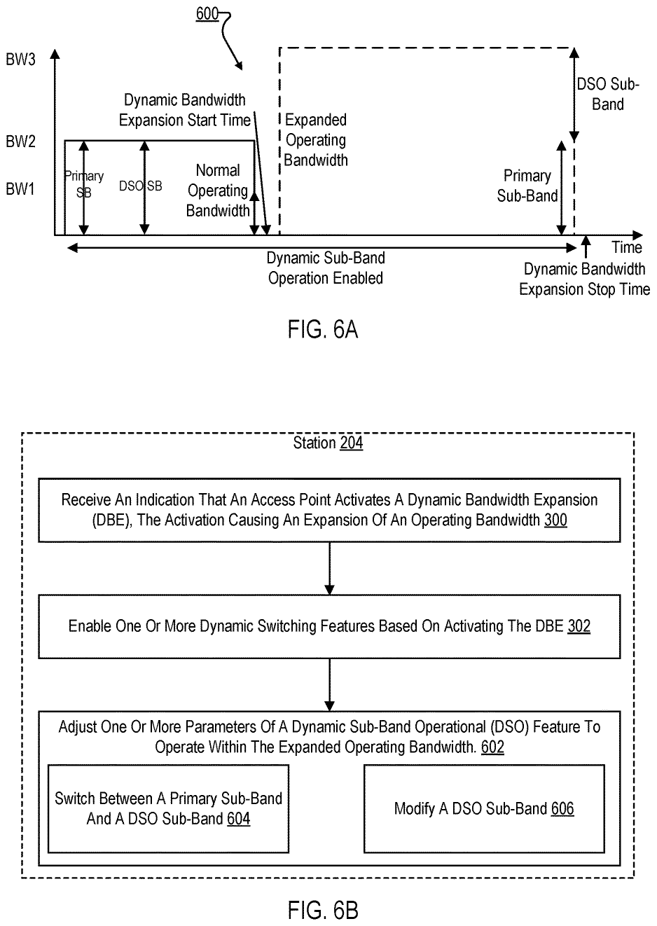

FIG. 5B therefore illustrates an example method executed by the station for adjusting one or more parameters of a NPCA feature in response to activation of a DBE. The sequence of operations shown in FIG. 5B demonstrates how the station may transition from enabling 302 the NPCA feature to adjusting 502 the one or more parameters, including switching 504 between the BSS primary channel and the NPCA primary channel or modifying 506 the NPCA primary channel, so that NPCA operation remains within the expanded operating bandwidth. FIG. 6A and FIG. 6B set forth example timing diagrams and flowcharts that expand upon the operations described with reference to FIG. 3 by detailing additional operations associated with adjusting parameters of a DSO feature in coordination with activation of a DBE, as further described herein.

For further explanation, FIG. 6A illustrates an example timing diagram 600 depicting coordination between activation of a DBE and operation of a DSO feature in accordance with embodiments of the present disclosure. The example timing diagram 600 of FIG. 6A can be carried out in a system similar to that of FIGS. 1 and 2. The timing relationships illustrated in FIG. 6A may correspond to operations performed by a station (e.g., the station 204) that enables and adjusts a DSO feature in response to activation of a DBE initiated by an access point (e.g., the access point 202).

FIG. 6A illustrates a first time interval during which the station 204 operates within a normal operating bandwidth prior to a scheduled DBE start time. At the DBE start time, the operating bandwidth transitions from the normal operating bandwidth to an expanded operating bandwidth that may include additional frequency segments identified as BW1, BW2, and BW3. During the expanded operating bandwidth interval, the DSO feature may be enabled so that the station 204 can operate on a DSO sub-band aligned with the expanded operating bandwidth. The timing diagram further illustrates a DBE stop time at which the operating bandwidth returns from the expanded operating bandwidth to the normal operating bandwidth, thereby establishing defined intervals during which DSO configuration may be adjusted in coordination with activation and termination of the DBE.

In some embodiments, the primary sub-band and the DSO sub-band illustrated in FIG. 6A may be configured so that the DSO sub-band corresponds to the expanded operating bandwidth during the DBE interval. For example, the station 204 may configure the DSO sub-band to reside within BW2 or BW3 of the expanded operating bandwidth while maintaining the primary sub-band within BW2 (normal BW). In other embodiments, the station 204 may adjust the DSO sub-band at or after the DBE start time so that both sub-bands align with frequency resources available during the expanded operating bandwidth interval. Upon occurrence of the DBE stop time, the station 204 may revert the DSO sub-band to values compatible with the normal operating bandwidth.

The timing relationships illustrated in FIG. 6A demonstrate how activation and termination of the DBE define boundaries for coordinated adjustment of DSO parameters. By aligning the primary sub-band and the DSO sub-band with the expanded operating bandwidth during the DBE interval, the station 204 may maintain consistent sub-band allocation and avoid operation outside available frequency resources. When the operating bandwidth transitions back to the normal operating bandwidth at the DBE stop time, the station 204 may adjust or restrict DSO operation to comply with the reduced bandwidth. FIG. 6B sets forth a flowchart illustrating an example method that details operations associated with adjusting one or more parameters of the DSO feature in coordination with activation of the DBE.

For further explanation, FIG. 6B sets forth a flowchart illustrating an example method for adjusting one or more parameters of a DSO feature in coordination with activation of a DBE in accordance with embodiments of the present disclosure. The operations shown in FIG. 6B may be performed by the station 204 following receipt of a scheduled indication of DBE activation and may further refine the enabling 302 operation described with reference to FIG. 3. The flowchart of FIG. 6B illustrates how the station 204 may modify DSO configuration parameters so that the DSO feature operates within the expanded operating bandwidth established by activation of the DBE.

The method of FIG. 6B discloses performance of receiving 300 the indication of activation of the DBE and enabling 302 the one or more dynamic switching features, including the DSO feature, as described with reference to FIG. 3, which may precede adjusting 602 one or more parameters of the DSO feature, as further described herein. In the method of FIG. 6B, receiving 300 the indication and enabling 302 the DSO feature may be performed as described with reference to FIG. 3 such that the DSO feature is active prior to parameter modification. Following enabling 302 the DSO feature, the method of FIG. 6B may include adjusting 602 one or more parameters of the DSO feature to operate within the expanded operating bandwidth. Performance of enabling 302 the DSO feature prior to adjusting 602 the one or more parameters may ensure that subsequent parameter modification occurs in coordination with activation of the DBE and within bandwidth constraints established by the expanded operating bandwidth.

More specifically, adjusting 602 the one or more parameters of the DSO feature may be carried out by modifying configuration values associated with a DSO sub-band so that the DSO feature operates within the expanded operating bandwidth established by activation of the DBE. Adjusting 602 the one or more parameters may include updating internal state information that defines which sub-band the station 204 uses for transmission and reception during operation of the DSO feature. Adjusting 602 the one or more parameters may therefore align operation of the DSO feature with frequency resources available during the expanded operating bandwidth interval. Performance of adjusting 602 the one or more parameters may establish a configuration in which subsequent transmissions and receptions performed under the DSO feature remain within bandwidth limits defined by activation of the DBE.

In some embodiments, adjusting 602 the one or more parameters of the DSO feature may include maintaining the primary sub-band within the normal operating bandwidth (e.g., BW2) and selecting or modifying a DSO sub-band within BW1, BW2, or BW3 consistent with operation within the expanded operating bandwidth established by activation of the DBE. For example, adjusting 602 the one or more parameters may include maintaining the primary sub-band within the normal operating bandwidth while configuring the DSO sub-band to extend into BW3 during the expanded operating bandwidth interval. In other embodiments, adjusting 602 the one or more parameters may include synchronizing application of modified DSO sub-band selections with the scheduled DBE activation time to ensure that the station 204 transitions to the updated configuration at a defined operating boundary. Adjusting 602 the one or more parameters in accordance with selected sub-band values and timing constraints may enable the station 204 to operate the DSO feature efficiently across BW1 through BW3 while maintaining compliance with IEEE 802.11 signaling semantics.

In the method of FIG. 6B, adjusting 602 the one or more parameters of the DSO feature includes switching 604 between a primary sub-band and a DSO sub-band or modifying 606 the DSO sub-band as is further described herein.

More specifically, adjusting 602 the one or more parameters of the DSO feature includes configuring a DSO sub-band for operation within the expanded operating bandwidth. In addition, switching 604 between channel access on a primary sub-band and channel access on a DSO sub-band may be performed during an operating phase based on channel conditions associated with the primary sub-band and the DSO sub-band or other operational requirements, after the DSO sub-band has been selected during a parameter configuration phase. In one or more examples, switching 604 may include detecting that channel conditions on the primary sub-band are unfavorable and transitioning communication procedures to the DSO sub-band within the expanded operating bandwidth. Switching 604 between channel access on the primary sub-band and the DSO sub-band may enable the station 204 to utilize additional sub-band resources while remaining within frequency limits defined by activation of the DBE.

In some embodiments, switching 604 between the primary sub-band and the DSO sub-band may be performed based on a previously selected DSO sub-band based on frequency availability within the expanded operating bandwidth established by activation of the DBE. For example, switching 604 between the primary sub-band and the DSO sub-band may include identifying that the primary sub-band resides within BW1 or BW2 of the expanded operating bandwidth and selecting the DSO sub-band within BW3 of the expanded operating bandwidth to extend transmission capability. In other embodiments, switching 604 between the primary sub-band and the DSO sub-band may include synchronizing the transition between the primary sub-band and the DSO sub-band with medium access control timing constraints defined by the IEEE 802.11 WLAN specification. Switching 604 between the primary sub-band and the DSO sub-band in accordance with selected sub-band values and timing constraints may enable the station 204 to efficiently utilize additional frequency resources made available during the DBE interval.

In addition, adjusting 602 the one or more parameters of the DSO feature also includes modifying 606 the DSO sub-band. Modifying 606 the DSO sub-band may be carried out by reassigning the DSO sub-band to a different frequency segment within BW1, BW2, or BW3 of the expanded operating bandwidth to improve transmission flexibility. In one or more examples, modifying 606 the DSO sub-band may include updating stored sub-band configuration parameters and applying the updated parameters at the scheduled DBE activation time so that DSO operation remains aligned with frequency resources available during the expanded operating bandwidth interval.

In some embodiments, modifying 606 the DSO sub-band may include selecting a sub-band value based on frequency occupancy information, interference measurements, or allocation policies associated with the station 204. For example, modifying 606 the DSO sub-band may include selecting a sub-band within BW3 of the expanded operating bandwidth that exhibits reduced interference relative to sub-bands within BW1 or BW2. Modifying 606 the DSO sub-band in accordance with selected sub-band values and operational constraints may enable the station 204 to maintain compliant and efficient DSO operation during the DBE interval.

The method steps of FIG. 6B collectively describe a process for adjusting parameters of a DSO feature in coordination with activation of a DBE. Receiving 300 the indication of the scheduled activation time, enabling 302 the DSO feature, and adjusting 602 the one or more parameters, including switching 604 between a primary sub-band and a DSO sub-band or modifying 606 the DSO sub-band, cooperate to align DSO operation with the expanded operating bandwidth. Through these operations, the station may transition from a DSO configuration associated with a normal operating bandwidth to a DSO configuration associated with the expanded operating bandwidth while maintaining compliance with signaling and capability constraints defined by the IEEE 802.11 WLAN specification. The coordinated execution of enabling 302 the DSO feature and adjusting 602 the one or more parameters may reduce configuration inconsistencies, minimize transition latency, and improve sub-band utilization during scheduled DBE activation events.

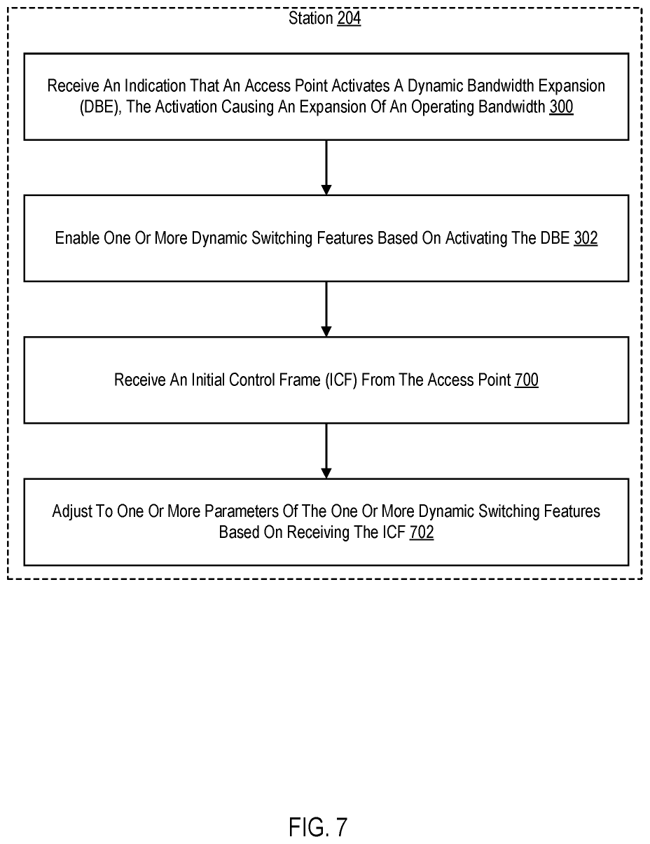

FIG. 6B therefore illustrates an example method executed by the station for adjusting one or more parameters of a DSO feature in response to activation of a DBE. The sequence of operations shown in FIG. 6B demonstrates how the station may transition from enabling 302 the DSO feature to adjusting 602 the one or more parameters, including switching 604 between the primary sub-band and the DSO sub-band or modifying 606 the DSO sub-band, so that DSO operation remains within the expanded operating bandwidth. FIG. 7 sets forth a flowchart illustrating an example method that expands upon the operations described with reference to FIG. 3 by detailing additional operations associated with initiating an adjustment to one or more parameters of dynamic switching features in response to receipt of an initial control frame, as further described herein.

For further explanation, FIG. 7 sets forth a flowchart illustrating an example method of initiating an adjustment to one or more parameters of dynamic switching features in response to receipt of an initial control frame in accordance with embodiments of the present disclosure. The example method of FIG. 7 can be carried out in a system similar to that of FIGS. 1 and 2. The method of FIG. 7 can be performed by a station (e.g., the station 204) configured to receive, or transmit, an initial control frame from an access point (e.g., the access point 202) and to initiate an adjustment to one or more parameters of one or more dynamic switching features in coordination with activation of a DBE to receive or transmit within an operating bandwidth associated with the DBE.

The method of FIG. 7 discloses performance of receiving 300 the indication of activation of the DBE and enabling 302 the one or more dynamic switching features as described with reference to FIG. 3, which may precede receiving 700, or transmitting, an initial control frame and initiating 702 an adjustment to one or more parameters of the one or more dynamic switching features, as further described herein. In the method of FIG. 7, receiving 300 the indication and enabling 302 the one or more dynamic switching features may be performed as described with reference to FIG. 3 such that at least one dynamic switching feature is active prior to receipt of the initial control frame. Following receipt 700 of the initial control frame from the access point 202, the method of FIG. 7 may include initiating 702 an adjustment to one or more parameters of the one or more dynamic switching features to receive or transmit within the expanded operating bandwidth. Performance of receiving 700, or transmitting, the initial control frame and initiating 702 the adjustment may ensure that parameter modification occurs in coordination with control signaling exchanged between the station 204 and the access point 202 under bandwidth constraints established by activation of the DBE.

More specifically, receiving 700, or transmitting, the initial control frame may be carried out by detecting and processing a control frame transmitted by the access point 202 during a transmission opportunity so that the station 204 obtains signaling information associated with one or more dynamic switching features. In some embodiments, transmitting a control frame to the access point 202 may include constructing the control frame based on one or more dynamic switching feature parameters and providing the control frame for transmission to the access point 202. Receiving 700, or transmitting, the initial control frame may include updating internal state information that reflects a requested transition of a DPS feature, a NPCA feature, or a DSO feature. Receiving 700, or transmitting, the initial control frame may therefore provide the signaling context necessary to determine whether parameter modification is required under current operating bandwidth conditions. Performance of receiving 700, or transmitting, the initial control frame may establish a basis for subsequent initiation 702 of parameter adjustments in coordination with activation of the DBE to enable the station 204 to receive or transmit within the operating bandwidth associated with the DBE.

In some embodiments, receiving 700, or transmitting, the initial control frame may include determining that the initial control frame contains a field indicating a requested transition between a low capability mode and a high capability mode of a DPS feature. In other embodiments, receiving 700, or transmitting, the initial control frame may include identifying a field specifying selection of a NPCA primary channel or allocation of a DSO sub-band within the expanded operating bandwidth. Receiving 700, or transmitting, the initial control frame may further include verifying that the requested transition complies with capability information and operational constraints associated with the station 204. Receiving 700, or transmitting, the initial control frame in accordance with defined signaling semantics may enable the station 204 to respond dynamically to feature-related control signaling exchanged during operation under the DBE interval to receive or transmit within the operating bandwidth associated with the DBE.

The method of FIG. 7 also includes initiating 702 an adjustment to one or more parameters of the one or more dynamic switching features in response to receiving 700 the initial control frame. Initiating 702 the adjustment may be carried out by applying configuration changes associated with a DPS feature, a NPCA feature, or a DSO feature based on signaling information extracted from the initial control frame. In one or more examples, initiating 702 the adjustment may include updating bandwidth parameters, primary channel selections, or sub-band allocations so that the dynamic switching feature operates in accordance with both the initial control frame and the expanded operating bandwidth established by activation of the DBE. Initiating 702 the adjustment may enable the station 204 to dynamically modify feature behavior within a defined transmission opportunity while maintaining compliance with IEEE 802.11 signaling constraints.

In some embodiments, initiating 702 the adjustment may include applying updated configuration parameters at a boundary of a transmission opportunity defined by medium access control timing rules specified by the IEEE 802.11 WLAN specification. For example, initiating 702 the adjustment may include transitioning a DPS feature from a low capability mode to a high capability mode at the start of a subsequent transmission opportunity in response to the initial control frame. In other embodiments, initiating 702 the adjustment may include selecting a NPCA primary channel or allocating a DSO sub-band for use during a defined interval within the expanded operating bandwidth. Initiating 702 the adjustment in accordance with requested transitions and timing constraints may enable the station 204 to dynamically adapt feature parameters while maintaining alignment with activation of the DBE.

The method steps of FIG. 7 collectively describe a process for initiating dynamic adjustment of one or more parameters of dynamic switching features in response to control signaling received during operation under a DBE interval. Receiving 300 the indication of the scheduled activation time, enabling 302 the one or more dynamic switching features, receiving 700, or transmitting, the initial control frame, and initiating 702 the adjustment to one or more parameters cooperate to align feature operation with both scheduled bandwidth expansion and real-time control signaling. Through these operations, the station 204 may transition from a first configuration state associated with previously applied feature parameters to a second configuration state responsive to the initial control frame while maintaining compliance with signaling and capability constraints defined by the IEEE 802.11 WLAN specification. The coordinated execution of receiving 700, or transmitting, the initial control frame and initiating 702 the adjustment may reduce signaling delays, improve responsiveness to transmission opportunity level requests, and enhance operational efficiency during scheduled DBE activation events to enable the station 204 to receive or transmit within the operating bandwidth associated with the DBE.

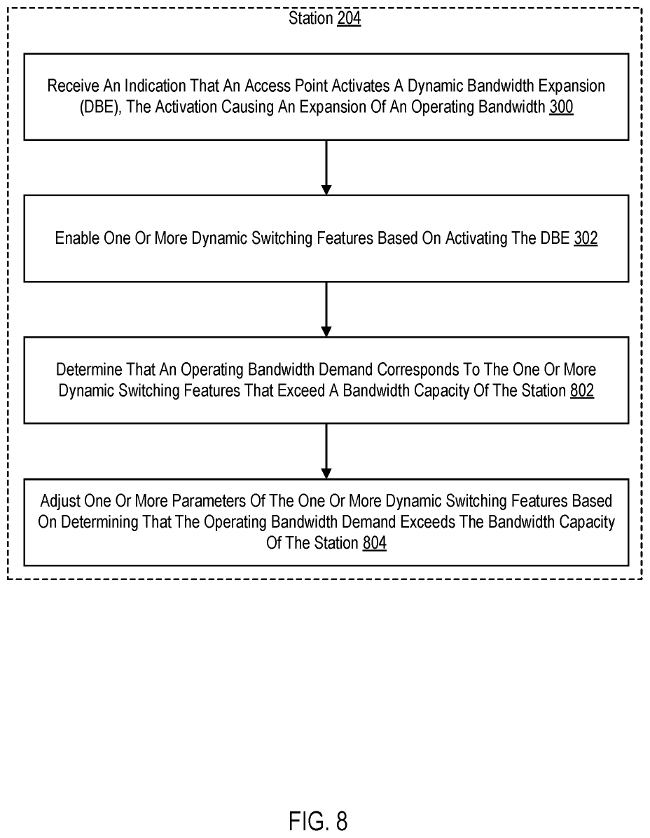

FIG. 7 therefore illustrates an example method executed by the station 204 for initiating adjustment of one or more parameters of dynamic switching features in response to receipt of an initial control frame. The sequence of operations shown in FIG. 7 demonstrates how the station 204 may transition from receiving 700, or transmitting, the initial control frame to initiating 702 parameter modification so that dynamic switching feature behavior remains aligned with activation of the DBE and ongoing transmission opportunity level signaling to enable the station 204 to receive or transmit within the operating bandwidth associated with the DBE. FIG. 8 sets forth a flowchart illustrating an example method that expands upon the operations described with reference to FIG. 3 by detailing additional operations associated with determining whether an operating bandwidth demand exceeds a bandwidth capacity of the station, as further described herein.

For further explanation, FIG. 8 sets forth a flowchart illustrating an example method of determining whether an operating bandwidth demand corresponding to one or more dynamic switching features exceeds a bandwidth capacity of a station (e.g., the station 204) in accordance with embodiments of the present disclosure. The example method of FIG. 8 can be carried out in a system similar to that of FIGS. 1 and 2. The method of FIG. 8 can be performed by the station 204 configured to evaluate bandwidth requirements associated with one or more dynamic switching features during activation of a DBE and to initiate an adjustment to one or more parameters when the operating bandwidth demand exceeds the bandwidth capacity of the station.

The method of FIG. 8 discloses performance of receiving 300 the indication of activation of the DBE and enabling 302 the one or more dynamic switching features as described with reference to FIG. 3, which may precede determining 802 whether an operating bandwidth demand corresponding to the one or more dynamic switching features exceeds a bandwidth capacity of the station and initiating 804 an adjustment to one or more parameters, as further described herein. In the method of FIG. 8, receiving 300 the indication and enabling 302 the one or more dynamic switching features may be performed as described with reference to FIG. 3 such that at least one dynamic switching feature is active prior to evaluation of bandwidth demand. Following enabling 302 the one or more dynamic switching features, the method of FIG. 8 may include determining 802 whether cumulative bandwidth requirements associated with the enabled features exceed a supported bandwidth capacity of the station 204. Performance of determining 802 the operating bandwidth demand prior to initiating 804 the adjustment may ensure that subsequent parameter modification occurs in coordination with activation of the DBE and within capability limits of the station 204.

More specifically, determining 802 whether the operating bandwidth demand corresponding to the one or more dynamic switching features exceeds the bandwidth capacity of the station 204 may be carried out by evaluating configuration values associated with a DPS feature, a NPCA feature, or a DSO feature against a maximum supported bandwidth of the station 204. Determining 802 whether the operating bandwidth demand exceeds the bandwidth capacity may include calculating a cumulative bandwidth requirement based on selected capability modes, primary channel selections, or sub-band allocations currently configured for the enabled dynamic switching features. Determining 802 whether the operating bandwidth demand exceeds the bandwidth capacity may therefore identify a condition in which operation within the expanded operating bandwidth would surpass hardware or signaling limits of the station 204. Performance of determining 802 whether the operating bandwidth demand exceeds the bandwidth capacity may establish a basis for subsequent initiation 804 of parameter adjustments to ensure continued operation within supported bandwidth limits defined by activation of the DBE.

In some embodiments, determining 802 whether the operating bandwidth demand exceeds the bandwidth capacity of the station 204 may include comparing a selected high capability bandwidth of a DPS feature, a configured NPCA primary channel, or an allocated DSO sub-band against a maximum bandwidth supported by the station 204. For example, determining 802 whether the operating bandwidth demand exceeds the bandwidth capacity may include identifying that combined operation of the DPS feature in a high capability mode and allocation of a DSO sub-band within BW3 exceeds a maximum supported bandwidth of the station 204. In other embodiments, determining 802 whether the operating bandwidth demand exceeds the bandwidth capacity may include evaluating hardware capability information stored at the station 204, including supported channels or processing limits, to assess whether simultaneous operation of multiple dynamic switching features remains within allowable bounds. Determining 802 whether the operating bandwidth demand exceeds the bandwidth capacity in accordance with capability limits and operational constraints may enable the station 204 to prevent configuration states that exceed supported bandwidth capacity during the DBE interval.

The method of FIG. 8 also includes initiating 804 an adjustment to one or more parameters of the one or more dynamic switching features in response to determining 802 that the operating bandwidth demand exceeds the bandwidth capacity of the station 204. Initiating 804 the adjustment may be carried out by modifying configuration values associated with a DPS feature, a NPCA feature, or a DSO feature so that cumulative bandwidth usage is reduced to a level within the supported bandwidth capacity of the station 204. In one or more examples, initiating 804 the adjustment may include adjusting the high capability bandwidth or low capability bandwidth of the DPS feature, selecting a different NPCA primary channel, or reallocating a DSO sub-band to a different frequency segment. Initiating 804 the adjustment may enable the station 204 to maintain compliant operation under activation of the DBE while preventing operation that exceeds hardware or signaling limits defined by the IEEE 802.11 WLAN specification.

In some embodiments, initiating 804 the adjustment may include selectively disabling at least one dynamic switching feature when combined bandwidth requirements of multiple enabled features exceed the bandwidth capacity of the station 204. For example, initiating 804 the adjustment may include maintaining operation of a DPS feature while temporarily disabling a DSO feature to ensure that total bandwidth usage remains within supported limits. In other embodiments, initiating 804 the adjustment may include dynamically reconfiguring one or more feature parameters at a transmission opportunity boundary so that reduced bandwidth settings are applied without interrupting ongoing communication sessions. Initiating 804 the adjustment in accordance with capability limits and operational policies may enable the station 204 to sustain stable and efficient operation during the DBE interval while avoiding configuration states that exceed supported bandwidth capacity.

The method steps of FIG. 8 collectively describe a process for ensuring that operation of one or more dynamic switching features remains within a bandwidth capacity of the station during activation of a DBE. Receiving 300 the indication of the scheduled activation time, enabling 302 the one or more dynamic switching features, determining 802 whether an operating bandwidth demand exceeds the bandwidth capacity, and initiating 804 an adjustment to one or more parameters cooperate to align feature operation with both the expanded operating bandwidth and capability limits of the station. Through these operations, the station may transition from a configuration state that exceeds supported bandwidth capacity to a configuration state that remains within allowable limits while maintaining compliance with signaling and capability constraints defined by the IEEE 802.11 WLAN specification. The coordinated execution of determining 802 the operating bandwidth demand and initiating 804 the adjustment may prevent unsupported configuration states, reduce transmission errors, and improve operational stability during scheduled DBE activation events.

FIG. 8 therefore illustrates an example method executed by the station for evaluating bandwidth demand and initiating parameter adjustments when supported bandwidth capacity would otherwise be exceeded. The sequence of operations shown in FIG. 8 demonstrates how the station may transition from enabling 302 the one or more dynamic switching features to determining 802 whether cumulative bandwidth requirements exceed supported limits and initiating 804 corrective adjustments so that operation remains within the expanded operating bandwidth and within station capability constraints. FIG. 9 sets forth a flowchart illustrating an example method that expands upon the operations described with reference to FIG. 3 by detailing additional operations associated with disabling one or more dynamic switching features in response to deactivation of a DBE, as further described herein.

For further explanation, FIG. 9 sets forth a flowchart illustrating an example method of disabling one or more dynamic switching features in response to deactivation of a DBE in accordance with embodiments of the present disclosure. The example method of FIG. 9 can be carried out in a system similar to that of FIGS. 1 and 2. The method of FIG. 9 can be performed by a station (e.g., the station 204) configured to detect deactivation of a DBE initiated by an access point (e.g., the access point 202) and to disable one or more dynamic switching features when the operating bandwidth transitions from an expanded operating bandwidth to a normal operating bandwidth.

The method of FIG. 9 discloses performance of receiving 300 the indication of activation of the DBE and enabling 302 the one or more dynamic switching features as described with reference to FIG. 3, which may precede disabling 900 the one or more dynamic switching features in response to deactivation of the DBE, as further described herein. In the method of FIG. 9, receiving 300 the indication and enabling 302 the one or more dynamic switching features may be performed as described with reference to FIG. 3 such that at least one dynamic switching feature is active during an expanded operating bandwidth interval. Following activation and subsequent deactivation of the DBE, the method of FIG. 9 may include disabling 900 the one or more dynamic switching features when the operating bandwidth transitions from the expanded operating bandwidth to a normal operating bandwidth. Performance of disabling 900 the one or more dynamic switching features may ensure that feature operation does not persist beyond bandwidth limits established after deactivation of the DBE.

More specifically, disabling 900 the one or more dynamic switching features may be carried out by transitioning a DPS feature, a NPCA feature, or a DSO feature from an enabled state to a disabled state when the operating bandwidth returns from the expanded operating bandwidth to the normal operating bandwidth. Disabling 900 the one or more dynamic switching features may include clearing configuration values associated with a high capability bandwidth of the DPS feature, deactivating a NPCA primary channel selection, or releasing a DSO sub-band allocation that extends beyond the normal operating bandwidth. Disabling 900 the one or more dynamic switching features may therefore prevent continued operation of feature parameters that were configured specifically for the expanded operating bandwidth. Performance of disabling 900 the one or more dynamic switching features may establish a configuration state in which subsequent transmissions and receptions remain confined to frequency resources available under the normal operating bandwidth following deactivation of the DBE. In some embodiments, disabling 900 the one or more dynamic switching features may also be performed in response to operating bandwidth reduction indicated by OMI, OMN, or AOM signaling.

In some embodiments, disabling 900 the one or more dynamic switching features may include selectively disabling only those dynamic switching features that require bandwidth beyond the normal operating bandwidth while maintaining operation of other features that remain compliant with the reduced bandwidth. For example, disabling 900 may include deactivating a DSO feature that utilizes BW3 of the expanded operating bandwidth while retaining a DPS feature configured to operate within BW1 or BW2 of the normal operating bandwidth. In other embodiments, disabling 900 may include synchronizing the transition of feature states with a scheduled DBE stop time to ensure that deactivation occurs at a defined operating boundary in accordance with IEEE 802.11 timing constraints. Disabling 900 the one or more dynamic switching features in accordance with selected feature states and timing rules may enable the station 204 to maintain compliant and stable operation following deactivation of the DBE.

The method steps of FIG. 9 collectively describe a process for disabling one or more dynamic switching features in coordination with deactivation of a DBE. Receiving 300 the indication of activation of the DBE, enabling 302 the one or more dynamic switching features during an expanded operating bandwidth interval, and disabling 900 the one or more dynamic switching features upon deactivation of the DBE cooperate to align feature operation with the normal operating bandwidth. Through these operations, the station may transition from a configuration associated with the expanded operating bandwidth to a configuration associated with the normal operating bandwidth while maintaining compliance with signaling and capability constraints defined by the IEEE 802.11 WLAN specification. The coordinated execution of enabling 302 the one or more dynamic switching features and disabling 900 the one or more dynamic switching features may reduce configuration inconsistencies and prevent operation outside frequency resources available after deactivation of the DBE.

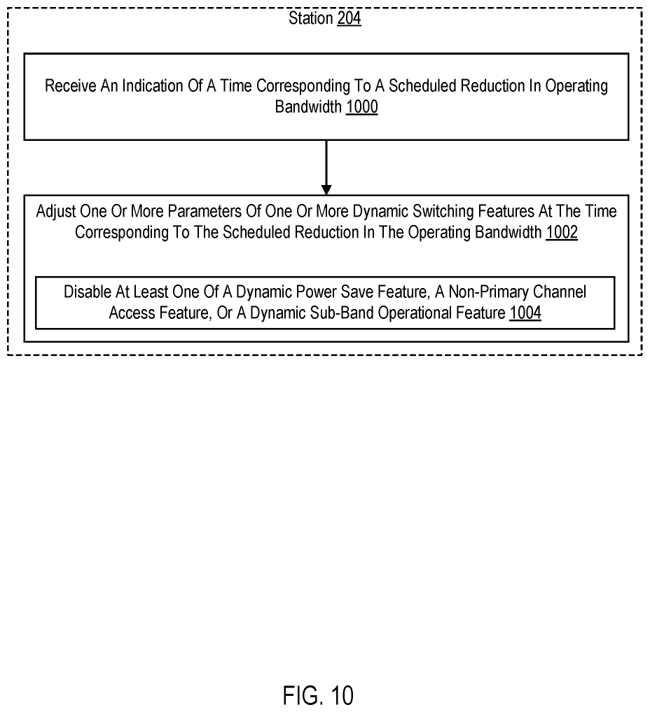

FIG. 9 therefore illustrates an example method executed by the station for disabling one or more dynamic switching features in response to deactivation of a DBE. The sequence of operations shown in FIG. 9 demonstrates how the station may transition from operation under the expanded operating bandwidth to disabling 900 the one or more dynamic switching features so that operation remains within the normal operating bandwidth. FIG. 10 sets forth an example method directed to scheduled reduction of operating bandwidth and adjustment of one or more dynamic switching features at a time corresponding to the scheduled reduction.

For further explanation, FIG. 10 sets forth a flowchart illustrating an example method of adjusting one or more dynamic switching features in response to a scheduled reduction in operating bandwidth in accordance with embodiments of the present disclosure. The example method of FIG. 10 can be carried out in a system similar to that of FIGS. 1 and 2. The method of FIG. 10 can be performed by a station (e.g., the station 204) configured to receive an indication of a time corresponding to a scheduled reduction in operating bandwidth and to adjust one or more parameters of one or more dynamic switching features at the time corresponding to the scheduled reduction.

The method of FIG. 10 includes receiving 1000, by the station, an indication of a time corresponding to a scheduled reduction in operating bandwidth. Receiving 1000 the indication may be carried out by receiving a management frame, control frame, or other signaling message transmitted by the access point 202 that specifies a scheduled time at which the operating bandwidth will be reduced. In one or more examples, receiving 1000 the indication may include extracting timing information that defines a transition from an expanded operating bandwidth to a reduced operating bandwidth. Receiving 1000 the indication may further include determining, based on the extracted timing information, when the station 204 must transition one or more dynamic switching features to comply with the reduced operating bandwidth in accordance with IEEE 802.11 WLAN signaling semantics.

In some embodiments, receiving 1000 the indication of the time corresponding to the scheduled reduction in operating bandwidth may include identifying that the indication corresponds to an operating mode indication, an operating mode notification, or an adaptive operating mode signaling message. For example, receiving 1000 the indication may include parsing one or more signaling fields that define a reduced operating bandwidth to be applied at a specified time. In other embodiments, receiving 1000 the indication may include verifying that the scheduled reduction applies to the station 204 based on capability information or association parameters. Receiving 1000 the indication in accordance with defined signaling semantics may enable the station 204 to prepare adjustments to one or more dynamic switching features prior to transition to the reduced operating bandwidth.

The method of FIG. 10 also includes adjusting 1002, by the station, one or more parameters of one or more dynamic switching features at the time corresponding to the scheduled reduction in the operating bandwidth. Adjusting 1002 the one or more parameters may be carried out by modifying configuration values associated with a DPS feature, a NPCA feature, or a DSO feature so that operation of the one or more dynamic switching features conforms to the reduced operating bandwidth. In one or more examples, adjusting 1002 the one or more parameters may include adjusting a high capability bandwidth or low capability bandwidth of a DPS feature, selecting an NPCA primary channel that is distinct from a BSS primary channel consistent with the reduced operating bandwidth, or reallocating a DSO sub-band within frequency resources remaining after the scheduled reduction. Adjusting 1002 the one or more parameters at the scheduled reduction time may enable the station 204 to maintain compliant operation under the reduced operating bandwidth defined by the received signaling.

In some embodiments, adjusting 1002 the one or more parameters may include adjusting a high capability bandwidth or low capability bandwidth of a DPS feature to a bandwidth value that resides within the reduced operating bandwidth. For example, adjusting 1002 may include reconfiguring the DPS feature to operate in a low capability mode aligned with BW1 or BW2 following the scheduled reduction. In other embodiments, adjusting 1002 may include selecting an NPCA primary channel or reallocating a DSO sub-band so that channel access and sub-band operation remain confined to frequency resources available under the reduced operating bandwidth. Adjusting 1002 the one or more parameters in accordance with selected bandwidth values and timing constraints may enable the station 204 to maintain compliant and efficient operation following the scheduled reduction in operating bandwidth.

In the method of FIG. 10, adjusting 1002 the one or more parameters of the one or more dynamic switching features can include disabling 1004 at least one of a DPS feature, a NPCA feature, or a DSO feature in response to the scheduled reduction in operating bandwidth. Disabling 1004 at least one dynamic switching feature may be carried out by transitioning the selected feature from an enabled state to a disabled state at the time corresponding to the scheduled reduction when continued operation of the feature would be incompatible with the reduced operating bandwidth. In one or more examples, disabling 1004 the selected dynamic switching feature may include deactivating a DSO feature that previously operated within BW3 when the operating bandwidth is reduced to BW1 and BW2, or deactivating a NPCA feature that depends on channel access outside the reduced bandwidth. Disabling 1004 the selected dynamic switching feature as part of adjusting 1002 the one or more parameters may ensure that operation of the station 204 remains aligned with the reduced operating bandwidth defined by the scheduled transition.

In some embodiments, disabling 1004 at least one dynamic switching feature may include evaluating which dynamic switching features rely on frequency segments removed by the scheduled reduction in operating bandwidth and selectively disabling only those features. For example, disabling 1004 the at least one dynamic switching feature may include maintaining operation of a DPS feature configured to operate within BW2 while disabling a DSO feature that extended into BW3 prior to the reduction. In other embodiments, disabling 1004 the at least one dynamic switching feature may include synchronizing feature deactivation with the scheduled reduction time so that disabling occurs at a defined operating boundary in accordance with IEEE 802.11 timing constraints. Disabling 1004 the at least one dynamic switching feature in response to the scheduled reduction may enable the station 204 to maintain compliant and stable operation as the operating bandwidth transitions to a reduced configuration.

The method steps of FIG. 10 collectively describe a process for adjusting parameters of one or more dynamic switching features in coordination with a scheduled reduction in operating bandwidth. Receiving 1000 the indication of the time corresponding to the scheduled reduction and adjusting 1002 the one or more parameters, including disabling 1004 at least one of a DPS feature, a NPCA feature, or a DSO feature, cooperate to align feature operation with the reduced operating bandwidth. Through these operations, the station may transition from a configuration associated with an expanded operating bandwidth to a configuration associated with a reduced operating bandwidth while maintaining compliance with signaling and capability constraints defined by the IEEE 802.11 WLAN specification. The coordinated execution of adjusting 1002 the one or more parameters and disabling 1004 at least one dynamic switching feature may reduce configuration inconsistencies, prevent operation outside available frequency resources, and improve operational stability during scheduled bandwidth reduction events.

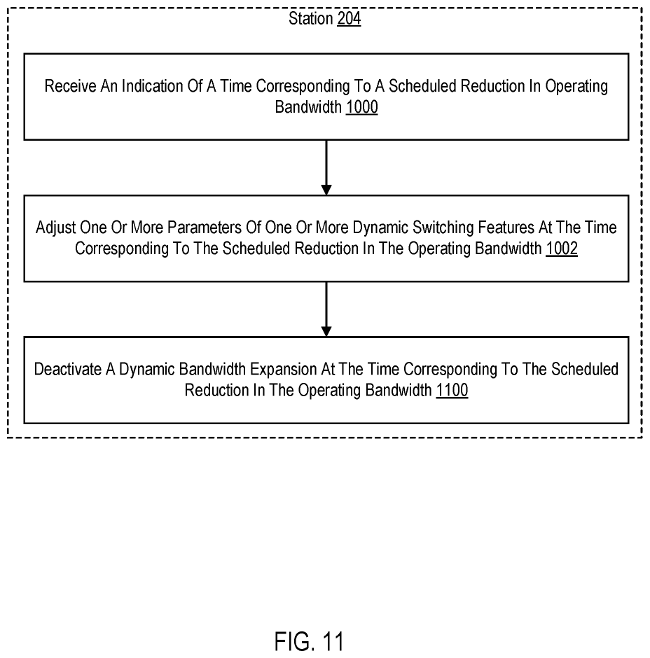

FIG. 10 therefore illustrates an example method executed by the station for adjusting one or more dynamic switching features in response to a scheduled reduction in operating bandwidth. The sequence of operations shown in FIG. 10 demonstrates how the station may transition from receiving 1000 the scheduled reduction indication to adjusting 1002 the one or more parameters, including disabling 1004 at least one dynamic switching feature, so that operation remains within the reduced operating bandwidth. FIG. 11 sets forth a flowchart illustrating an example method that expands upon the operations described with reference to FIG. 10 by detailing additional operations associated with deactivating a DBE at a time corresponding to the scheduled reduction in operating bandwidth, as further described herein.

For further explanation, FIG. 11 sets forth a flowchart illustrating an example method of deactivating a DBE at a time corresponding to a scheduled reduction in operating bandwidth in accordance with embodiments of the present disclosure. The example method of FIG. 11 can be carried out in a system similar to that of FIGS. 1 and 2. The method of FIG. 11 can be performed by a station (e.g., the station 204) configured to receive an indication of a time corresponding to a scheduled reduction in operating bandwidth and to deactivate a DBE at the time corresponding to the scheduled reduction.

The method of FIG. 11 discloses performance of receiving 1000 the indication of the time corresponding to the scheduled reduction in operating bandwidth and adjusting 1002 the one or more parameters of the one or more dynamic switching features as described with reference to FIG. 10, which may precede deactivating 1100 the DBE at the time corresponding to the scheduled reduction, as further described herein. In the method of FIG. 11, receiving 1000 the indication and adjusting 1002 the one or more parameters may be performed such that operation of the station 204 is prepared for transition to a reduced operating bandwidth. Following the scheduled reduction time, the method of FIG. 11 may include deactivating 1100 the DBE so that the operating bandwidth transitions from the expanded operating bandwidth to the reduced operating bandwidth. Performance of deactivating 1100 the DBE at the scheduled reduction time may ensure that operating bandwidth state information of the station 204 remains aligned with signaling semantics defined by the IEEE 802.11 WLAN specification.

More specifically, deactivating 1100 the DBE may be carried out by transitioning an operating bandwidth state of the station 204 from an expanded operating bandwidth to a reduced operating bandwidth at the time corresponding to the scheduled reduction. Deactivating 1100 the DBE may include clearing configuration values associated with additional frequency segments enabled during activation of the DBE and updating internal state information to reflect operation within the reduced operating bandwidth. Deactivating 1100 the DBE may therefore terminate availability of frequency resources that were introduced during the expanded operating bandwidth interval. Performance of deactivating 1100 the DBE may establish a configuration state in which subsequent transmissions and receptions remain confined to frequency resources defined by the reduced operating bandwidth following the scheduled transition.

In some embodiments, deactivating 1100 the DBE may include synchronizing the transition from the expanded operating bandwidth to the reduced operating bandwidth with a defined timing boundary specified by the IEEE 802.11 WLAN specification. For example, deactivating 1100 the DBE may include applying the reduced operating bandwidth at a beacon boundary or at a transmission opportunity boundary to ensure consistent operation across associated stations. In other embodiments, deactivating 1100 the DBE may include confirming receipt of signaling associated with the scheduled reduction prior to updating operating bandwidth state information. Deactivating 1100 the DBE in accordance with defined timing and signaling constraints may enable the station 204 to maintain compliant and stable operation during transition from the expanded operating bandwidth to the reduced operating bandwidth.

The method steps of FIG. 11 collectively describe a process for deactivating a DBE in coordination with a scheduled reduction in operating bandwidth. Receiving 1000 the indication of the time corresponding to the scheduled reduction, adjusting 1002 the one or more parameters of the one or more dynamic switching features, and deactivating 1100 the DBE cooperate to align operating bandwidth state and feature configuration with the reduced operating bandwidth. Through these operations, the station may transition from operation under an expanded operating bandwidth to operation under a reduced operating bandwidth while maintaining compliance with signaling and capability constraints defined by the IEEE 802.11 WLAN specification. The coordinated execution of adjusting 1002 the one or more parameters and deactivating 1100 the DBE may prevent operation outside available frequency resources and ensure consistency between scheduled bandwidth signaling and an actual operating bandwidth state.

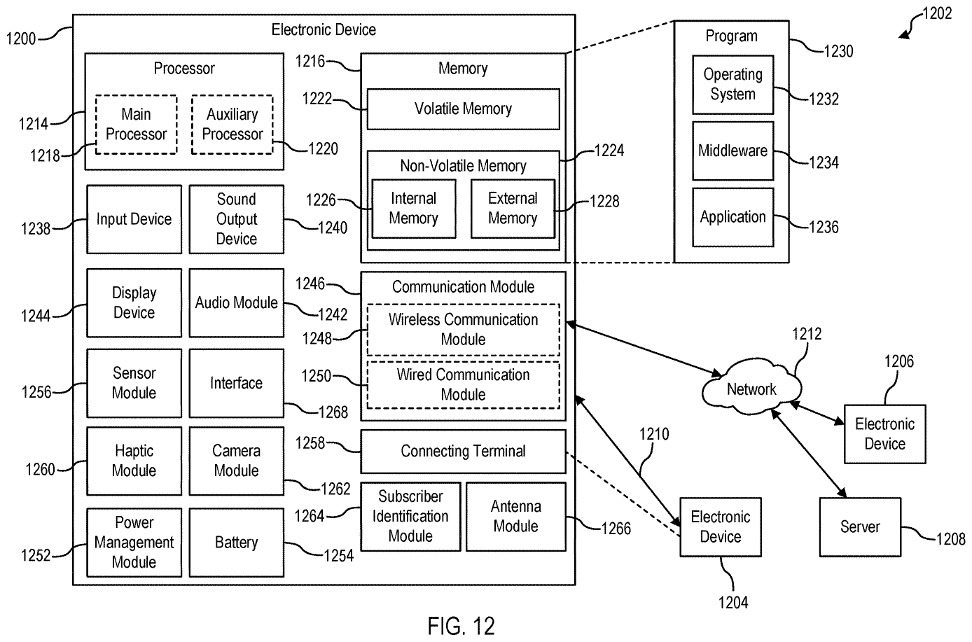

FIG. 11 therefore illustrates an example method executed by the station for deactivating a DBE at a time corresponding to a scheduled reduction in operating bandwidth. The sequence of operations shown in FIG. 11 demonstrates how the station may transition from receiving 1000 the scheduled reduction indication and adjusting 1002 the one or more parameters to deactivating 1100 the DBE so that operation remains within the reduced operating bandwidth. FIG. 12 illustrates an example electronic device architecture in which coordinated coexistence of operating mode switching operations may be implemented, as further described herein.

FIG. 12 is a block diagram of an electronic device 1200 in a network environment 1202 in accordance with embodiments of the present disclosure. The electronic device 1200 may operate independently or in conjunction with one or more other electronic devices 1204 or 1206, such as access points or stations, and one or more servers 1208 through a first network 1210 (e.g., a local communication network or short-range communication network) or a second network 1212 (e.g., a wide-area communication network). The electronic device 1200 may correspond to, or include, the functional components of the computing device 100 described with reference to FIG. 1 and may support coordination among the access points and stations described herein. For example, the electronic device 1200 may execute one or more functionalities associated with receiving scheduled indications of DBE activation or reduction, enabling or disabling dynamic switching features, adjusting feature parameters to align with expanded or reduced operating bandwidths, and deactivating a DBE at a scheduled reduction time to perform one or more operations associated with coordinated coexistence of operating mode switching operations, including the method steps described with reference to FIGS. 3, 4B, 5B, and 6B-11.

Referring to FIG. 12, the components of the electronic device 1200 illustrated therein will now be described in additional detail. These components may collectively enable the electronic device 1200 to execute the systems and methods associated with coordinated coexistence of operating mode switching operations, including scheduled bandwidth expansion, scheduled bandwidth reduction, dynamic switching feature enablement, parameter adjustment, and DBE deactivation described throughout this disclosure. While particular components are shown in FIG. 12, additional or alternative components may be included in other embodiments, and the described components may be implemented as discrete hardware modules, integrated circuits, firmware elements, software modules, or combinations thereof.

A processor 1214 may control overall operation of the electronic device 1200 and execute instructions stored in a memory 1216 to perform operating mode coordination and dynamic feature control operations. The processor 1214 may include a main processor 1218 and an auxiliary processor 1220 that can operate independently or cooperatively to manage computational and communication tasks associated with receiving scheduled indications of DBE activation or reduction, enabling dynamic switching features, adjusting feature parameters, evaluating bandwidth capacity constraints, and deactivating a DBE at a scheduled reduction time. The main processor 1218 may execute high-level operations associated with processing management frames and control frames, determining operating bandwidth transitions, and coordinating adjustments of DPS, NPCA, or DSO features. The auxiliary processor 1220 may perform specialized functions, such as evaluating bandwidth demand corresponding to enabled dynamic switching features, monitoring timing boundaries associated with scheduled transitions, or maintaining feature state information during transmission opportunity level signaling exchanges. In some embodiments, the auxiliary processor 1220 may remain active while the main processor 1218 operates in a reduced-power state, maintaining coordination signaling and monitoring operating bandwidth conditions across successive bandwidth transition events.

The memory 1216 may include both volatile memory 1222 and non-volatile memory 1224 configured to store data and instructions used by the processor 1214 during operation of the electronic device 1200. The non-volatile memory 1224 may include internal memory 1226 and external memory 1228 that may store persistent datasets, software modules, and configuration parameters used for DBE activation and deactivation control, dynamic switching feature enablement, parameter adjustment logic, and bandwidth capacity evaluation. The memory 1216 may also store a program 1230 that may include an operating system 1232, middleware 1234, and one or more applications 1236 executed by the processor 1214 to perform operations associated with receiving scheduled indications of operating bandwidth changes, enabling or disabling DPS, NPCA, or DSO features, modifying feature parameters to align with expanded or reduced operating bandwidths, and deactivating a DBE at a scheduled reduction time. In some embodiments, the memory 1216 may also maintain historical bandwidth transition records, capability information associated with the electronic device 1200, feature configuration state information, and policy parameters used to support real-time operating mode coordination in dynamic WLAN environments.

An input device 1238 may receive user input, control parameters, or configuration data during operation of the electronic device 1200. The input device 1238 may include a touchscreen, keyboard, keypad, or other interface mechanisms that allow a user or system administrator to configure operating bandwidth policies, enable or disable DPS, NPCA, or DSO features, and define thresholds associated with bandwidth capacity evaluation. In some embodiments, the input device 1238 may provide interfaces for specifying DBE activation or reduction preferences, selecting primary channel or sub-band allocation strategies, or initiating diagnostic operations associated with operating mode switching behavior. The input device 1238 may further support firmware-level inputs that define timing tolerances, transition policies, or synchronization parameters used during coordinated coexistence of operating mode switching operations.

A sound output device 1240 may output audio signals generated by the electronic device 1200. The sound output device 1240 may include one or more speakers, receivers, or other audio transducers configured to provide system notifications, alerts, or operational feedback during operating mode coordination events. In some embodiments, the sound output device 1240 may emit alerts indicating operating bandwidth transitions, such as activation of a DBE, scheduled reduction in operating bandwidth, or deactivation of a DBE. The sound output device 1240 may operate in conjunction with an audio module 1242 to enable audio-based diagnostics or alerting in wireless communication environments. For example, during operation under a DBE interval, the audio module 1242 may produce distinct tones or voice prompts corresponding to different processing stages, such as enabling a DPS feature, adjusting NPCA parameters, evaluating bandwidth capacity, or disabling a dynamic switching feature, allowing operators to monitor performance of the electronic device 1200 without reliance on a visual indicator.

A display device 1244 may visually present information generated by the processor 1214 to a user of the electronic device 1200. The display device 1244 may include a flat-panel display, touchscreen, or projection-based display configured to render graphical interfaces and data visualizations related to operating bandwidth transitions and dynamic switching feature states. In some embodiments, the display device 1244 may present real-time status of DBE activation, scheduled reduction in operating bandwidth, enabling or disabling of DPS, NPCA, or DSO features, and evaluation of bandwidth capacity conditions. The display device 1244 may further provide dashboards depicting current operating bandwidth, primary channel or sub-band selections, feature enablement states, and timing information associated with scheduled transitions, thereby supporting monitoring and configuration of coordinated coexistence of operating mode switching operations.

A communication module 1246 may enable the electronic device 1200 to transmit and receive data through a local communication network or a wide-area communication network. The communication module 1246 may include a wireless communication module 1248 and a wired communication module 1250, which may operate independently or cooperatively to support real-time transmission and receipt of management frames, control frames, and data frames associated with DBE activation, scheduled reduction in operating bandwidth, and dynamic switching feature signaling. In one or more embodiments, the communication module 1246 may exchange operating bandwidth configuration parameters, feature enablement states, timing information, or coordination data with other electronic devices or with the server 1208 to support distributed coordination of operating mode switching operations across multiple stations and access points.

A power management module 1252 may regulate power distribution and consumption among the components of the electronic device 1200. The power management module 1252 may monitor voltage and current supplied to the processor 1214, the memory 1216, the communication module 1246, and other subsystems to ensure stable operation during operating bandwidth transitions and dynamic switching feature adjustments. A battery 1254 may provide electrical power to one or more of these components and may maintain continuous operation of the electronic device 1200 during mobile or remote deployments within the network environment 1202. In some embodiments, the battery 1254 may preserve operating bandwidth configuration parameters, feature enablement states, and timing information associated with scheduled DBE activation or reduction during temporary power interruptions to support seamless continuation of coordinated coexistence of operating mode switching operations.

A sensor module 1256 may detect operational, environmental, or performance-related conditions within the electronic device 1200 and generate corresponding data signals for processing by the processor 1214. The sensor module 1256 may include temperature sensors, RF quality monitors, signal strength indicators, or interference detectors that influence operating bandwidth decisions, feature enablement states, or parameter adjustment thresholds. In some embodiments, the sensor module 1256 may monitor link-quality metrics or interference levels associated with BW1, BW2, or BW3 to support adaptive adjustment of DPS, NPCA, or DSO configuration during activation or deactivation of a DBE. The sensor module 1256 may further provide measurement data used to evaluate whether operation within an expanded operating bandwidth remains efficient or whether adjustment of one or more dynamic switching features is warranted under prevailing network conditions.

A connecting terminal 1258 may include one or more physical connectors that enable the electronic device 1200 to interface with external systems or peripheral devices. The connecting terminal 1258 may support high-speed data transfer standards such as Universal Serial Bus (USB), Peripheral Component Interconnect Express (PCIe), Ethernet, or serial interfaces to facilitate exchange of operating bandwidth configuration data, feature state information, parameter adjustment records, or diagnostic information. In some embodiments, the connecting terminal 1258 may support debugging, provisioning, or calibration tools used to verify DBE activation timing, scheduled reduction signaling, dynamic switching feature configuration, or bandwidth capacity evaluation logic implemented by the electronic device 1200.

A haptic module 1260 may provide tactile feedback to a user of the electronic device 1200 during operation. For example, the haptic module 1260 may generate vibrational feedback when the device detects activation of a DBE, applies an adjustment of one or more dynamic switching features, determines that an operating bandwidth demand exceeds a bandwidth capacity, or completes deactivation of a DBE following a scheduled reduction in operating bandwidth. In some embodiments, the haptic module 1260 may provide distinct tactile patterns corresponding to different operational states, such as transition to an expanded operating bandwidth, transition to a reduced operating bandwidth, or disabling of a dynamic switching feature due to bandwidth constraints.

A camera module 1262 may capture still images or video for diagnostics, environmental awareness, or device state verification. In some embodiments, the camera module 1262 may capture visual indicators associated with antenna positioning, physical installation conditions, or environmental factors that may affect wireless channel quality and operating bandwidth performance. The camera module 1262 may provide captured image or video data to the processor 1214 or the communication module 1246 for diagnostic analysis, remote monitoring, or maintenance operations related to DBE activation, scheduled bandwidth reduction, or coordinated coexistence of operating mode switching operations.

A subscriber identification module 1264 may store authentication credentials, device identifiers, or security keys used by the communication module 1246 to access secured wireless networks, enterprise infrastructure, or cloud-based coordination services. An antenna module 1266 may enable wireless transmission and reception of signals, including IEEE 802.11 WLAN signals used for transmission and receipt of management frames, control frames, and data frames associated with DBE activation, scheduled reduction in operating bandwidth, and dynamic switching feature signaling. An interface 1268 may support communication and data exchange between the electronic device 1200 and external peripherals, network equipment, diagnostic systems, or distributed control entities involved in coordinated coexistence of operating mode switching operations.

FIG. 12 therefore illustrates an example electronic device 1200 and network environment 1202 that can implement the systems and methods for coordinating coexistence of operating mode switching operations described with reference to FIGS. 3, 4B, 5B, and 6B-11. The arrangement of components shown in FIG. 12 provides a hardware and network foundation for carrying out any of the method steps described herein, including receiving scheduled indications of DBE activation or scheduled reduction in operating bandwidth, enabling or disabling DPS, NPCA, or DSO features, adjusting feature parameters to align with expanded or reduced operating bandwidths, evaluating bandwidth capacity constraints, and deactivating a DBE at a scheduled reduction time.

The systems, architectures, and methods described herein collectively provide a wireless communication framework that enables coordinated coexistence of operating mode switching operations within WLAN deployments. The described embodiments illustrate how a station can respond to scheduled activation and deactivation of a DBE and to scheduled reduction in operating bandwidth by enabling, adjusting, or disabling dynamic switching features including DPS, NPCA, and DSO. By aligning feature configuration with expanded or reduced operating bandwidth states and by evaluating bandwidth capacity constraints prior to applying configuration changes, the disclosed techniques may reduce signaling overhead, prevent operation outside available frequency resources, and improve spectral efficiency under IEEE 802.11 constraints. The coordinated interaction among the electronic device, one or more access points, one or more stations, and associated network infrastructure may further enable consistent operating semantics across scheduled and dynamic operating mode transitions, thereby enhancing throughput, flexibility, and interoperability in next-generation WLAN environments. While specific configurations, signaling sequences, and architectural arrangements have been described with reference to the accompanying figures, variations in network topology, device implementation, signaling parameters, and control logic may be implemented to achieve similar operational and performance benefits consistent with embodiments of the present disclosure.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for adjusting operating modes of a station, the method comprising:
receiving, by a station, an indication that an access point activates a dynamic bandwidth expansion (DBE), the activation causing an expansion of an operating bandwidth; and
enabling, by the station, one or more dynamic switching features based on activating the DBE, wherein the dynamic switching features comprise at least one of a dynamic power save (DPS) feature, a non-primary channel access (NPCA) feature, or a dynamic sub-band operational (DSO) feature.

2. The method of claim 1, further comprising:
adjusting, by the station, one or more parameters of the DPS feature to operate within the expanded operating bandwidth.

3. The method of claim 2, wherein adjusting the one or more parameters of the DPS feature comprises:
modifying, by the station, a bandwidth capability of the DPS feature.

4. The method of claim 1, further comprising:
adjusting, by the station, one or more parameters of the NPCA feature to operate within the expanded operating bandwidth.

5. The method of claim 4, wherein adjusting the one or more parameters of the NPCA feature comprises:
switching, by the station, between a basic service set (BSS) primary channel and a NPCA primary channel.

6. The method of claim 4, wherein adjusting the one or more parameters of the NPCA feature comprises:
modifying, by the station, a NPCA primary channel.

7. The method of claim 1, further comprising:
adjusting, by the station, one or more parameters of the DSO feature to operate within the expanded operating bandwidth.

8. The method of claim 7, wherein adjusting the one or more parameters of the DSO feature further comprises:
switching, by the station, between a primary sub-band and a DSO sub-band.

9. The method of claim 7, wherein adjusting the one or more parameters of the DSO feature further comprises:
modifying, by the station, a DSO sub-band.

10. The method of claim 1, further comprising:
receiving, by the station, an initial control frame (ICF) from the access point; and
adjusting one or more parameters of the one or more dynamic switching features based on receiving the ICF.

11. The method of claim 1, further comprising:
transmitting, by the station, an ICF from the access point; and
adjusting one or more parameters of the one or more dynamic switching features based on transmitting the ICF.

12. The method of claim 1, further comprising:
determining, by the station, that an operating bandwidth demand corresponds to the one or more dynamic switching features that exceed a bandwidth capacity of the station; and
adjusting one or more parameters of the one or more dynamic switching features based on determining that the operating bandwidth demand exceeds the bandwidth capacity of the station.

13. The method of claim 1, further comprising:
disabling, by the station, the one or more dynamic switching features based on a deactivation of the DBE, wherein the deactivation causes a reduction of the operating bandwidth.

14. The method of claim 1, further comprising:
transmitting, by the station, the indication that the access point activates the DBE.

15. The method of claim 1, further comprising:
receiving, by the station, an indication associated with a change in operating bandwidth, the change in operating bandwidth comprising at least one of a reduction or an expansion of the operating bandwidth indicated by an operating mode indication (OMI), an operating mode notification (OMN), or an adaptive operating mode (AOM); and
impacting, by the station, one or more dynamic switching features based on the change in operating bandwidth, wherein impacting the one or more dynamic switching features comprises at least one of enabling, disabling, or adjusting one or more parameters of at least one of the DPS feature, the NPCA feature, or the DSO feature.

16. A method for adjusting operating modes of a station, the method comprising:
receiving, by a station, an indication of a time corresponding to a scheduled reduction in operating bandwidth; and
adjusting, by the station, one or more parameters of one or more dynamic switching features at the time corresponding to the scheduled reduction in the operating bandwidth, wherein the dynamic switching features comprise at least one of a dynamic power save (DPS) feature, a non-primary channel access (NPCA) feature, or a dynamic sub-band operational (DSO) feature.

17. The method of claim 16, wherein the indication comprises at least one of an OMI, an OMN, or an AOM.

18. The method of claim 16, wherein adjusting the one or more parameters comprises:
disabling, by the station, at least one of the DPS feature, the NPCA feature, or the DSO feature.

19. The method of claim 16, further comprising:
deactivating, by the station, a dynamic bandwidth expansion at the time corresponding to the scheduled reduction in the operating bandwidth.

20. A system for adjusting operating modes of a station, the system comprising:
a memory; and
a processing device, operatively coupled to the memory, the processing device configured to:
receive an indication that an access point activates a dynamic bandwidth expansion (DBE), the activation causing an expansion of an operating bandwidth; and
enable one or more dynamic switching features based on activating the DBE, wherein the dynamic switching features comprise at least one of a dynamic power save (DPS) feature, a non-primary channel access (NPCA) feature, or a dynamic sub-band operational (DSO) feature.
